(19) United States
(12) Patent Application Publication
(10) Pub. No.: US 2024/0168435 A1
(43) Pub. Date: May 23, 2024

(54) HOLOGRAPHIC DISPLAYS AND METHODS

(71) Applicant: VividQ Limited, London (GB)

(72) Inventors: Andrzej KACZOROWSKI, London (GB); Alfred James NEWMAN, London (GB); Christian FIELDHOUSE, London (GB); Indi PRITCHARD, London (GB); Amy HARRIS, London (GB); Darius Martin SULLIVAN, London (GB)

(21) Appl. No.: 18/416,450

(22) Filed: Jan. 18, 2024

Related U.S. Application Data
(63) Continuation of application No. PCT/GB2022/051936, filed on Jul. 22, 2022.

(30) Foreign Application Priority Data
Jul. 23, 2021 (GB) 2110606.7

(51) Int. Cl. G03H 1/26

(52) U.S. Cl. CPC G03H 1/26; G03H 2226/02

(57) ABSTRACT

A method of generating a computer-generated hologram from a three-dimensional image comprising a plurality of two-dimensional image layers is provided. The method comprises generating hologram data for each layer of the image, and updating the hologram data of at least one layer of the image based on the hologram data of the other layers of the image.

### CROSS-REFERENCE TO RELATED APPLICATIONS

This application is a continuation under 35 U.S.C. § 120 of International Application No. PCT/GB2022/051936, filed Jul. 22, 2022, which claims priority to United Kingdom Application No. GB 2110606.7, filed Jul. 23, 2021, under 35 U.S.C. § 119(a). Each of the above-referenced patent applications is incorporated by reference in its entirety.

### BACKGROUND

### Technical Field

The present invention relates to methods of generating holograms, methods of displaying holograms, and holographic displays.

### Background

Holographic displays employing Computer-Generated Holographic (CGH) patterns produce an image by means of diffraction and interference of light. A diffraction pattern (also called a hologram) is calculated digitally from two or three dimensional data and forms a two or three-dimensional image in space when illuminated by coherent, or at least partially coherent, light. Unlike an image displayed on a conventional display, which is modulated only for amplitude, holographic displays modulate phase and/or amplitude to result in an image which preserves depth information at a viewing position. The modulation in a holographic display can be achieved by passing at least partially coherent light (such as from a laser) via a Spatial Light Modulator (SLM). Such holographic displays can display both three-dimensional images (images of objects that appear to exist in three dimensions) and two-dimensional images (such as a conventional display but at a controllable apparent distance from the viewer) depending on the pattern of phase produced by the display.

To display a hologram, elements/pixels of the SLM are controlled according to a digital representation of the image to be displayed. A two or three-dimensional image provides an input and the image is then processed to generate hologram data which is used to drive the elements of the SLM.

The hologram data therefore determines how each element of the SLM modulates the phase and/or amplitude of a light ray. The hologram data may therefore be an array of phase modulation data. As is well known, phase can be represented as complex values. In some cases, hologram data may be used directly for display on the SLM, in other cases the hologram data may be additionally processed before being displayed, such as by summing hologram data of individual image layers to form a 3-dimensional hologram.

Hologram data for a particular image may contain phase modulation data across a full range of 0 to 2π radians. However, in practice, continuous modulation is not possible and the display will instead offer a finite number of discrete phase values. For example, Nematic SLMs may allow 256 discrete phase values within the range of 0 to 2π radians. At the extreme some SLMs, such as those using Smectic C* liquid crystal SLMs also referred to as “ferroelectric liquid crystals”, may allow only 2 discrete phase values within the range of 0 to a radians. As is well known, SLMs can also modulate amplitude as well as phase. Similarly other devices than SLMs can be used to modulate a displayed CGH, for example LCD amplitude modulators.

Accordingly, the hologram data determined during processing is quantized based on the specific SLM being used to display the CGH. This quantization lowers the quality of the displayed hologram. For example, the displayed hologram may have a low contrast and/or contain substantial noise.

Techniques to improve the quality of a CGH when quantized for display have been proposed. This includes Iterative Fourier Transform Algorithm (IFTA) and One-Step Phase Retrieval (OSPR). An example of an IFTA is the Gerchberg-Saxton (GS) algorithm which may modify initial image data based on random phase data and iteratively converts the image data into hologram data and vice versa, while applying certain constraints. During each iteration, new phase data is retrieved which is then used to constrain the image data for the next iteration. This iterative process is repeated, with each iteration improving the image quality. The numbers of iterations required are high, possibly 100 or more, increasing the resource requirements for calculation.

OSPR displays many holograms depicting the same image, but having uncorrelated noise patterns, in quick succession. On viewing, the uncorrelated noise is averaged out by the viewer's eye and the overall noise perceived by the viewer is reduced. This requires both a display sufficiently fast to display all the images in quick succession, and increases the resource requirements to calculate all the additional images for display.

Accordingly, what is needed are methods of improving the quality of quantised holograms in a CGH display with reduced resource requirements and/or computational burden.

### SUMMARY

When used with an SLM capable of only modulating phase, an objective of a prior IFTA is to generate hologram data which has constant amplitude (to represent the laser profile on the SLM, which effectively has a flat amplitude distribution) and a phase which closely matches the values that the SLM is capable of reproducing. Problems can arise when using prior IFTA methods for generating a three-dimensional hologram. Three-dimensional holograms may be generated by representing a three-dimensional image as two or more separate layers, each layer representing a two-dimensional slice of the three-dimensional image. Each layer may therefore be referred to as an image layer, each image layer comprising image data. In one example method of displaying a three-dimensional hologram, hologram data is first generated for each layer at the appropriate distance from the viewer and then the hologram data of all layers is summed together to generate combined hologram data. It will be appreciated that other methods are also possible, for example, the hologram data may be generated for a first layer, which is then propagated to the second layer before being summed and propagated to the third layer, where it is summed with the third layer hologram data. In either case, display of such combined hologram data results in a perception of a three-dimensional image. However, if the hologram data for each layer has been generated by the methods described above (such as based on an IFTA), the resultant hologram is of poor quality because the hologram data for each layer has been optimised to have a fixed amplitude but when summed together with the other layers, this property is lost. The combined hologram data now results in a low quality image. Put another way, the process of summing layers of hologram data that has been generated using an IFTA, destroys the much if not all the benefit achieved by the earlier iterations.

The inventors have therefore devised a method of modifying/updating the hologram data of one or more layers to compensate for this effect, such that the combined hologram data results in a high-quality hologram and the benefits of IFTA processing can be obtained for layer-based three-dimensional holograms.

According to a first aspect of the present invention, there is provided a method of generating a computer-generated hologram from a three-dimensional image, comprising a plurality of two-dimensional image layers, the method comprising: (i) generating hologram data for each layer of the image, and (ii) updating the hologram data of at least one layer of the image based on the hologram data of the other layers of the image.

In contrast to prior methods, this allows the entire final hologram to be considered when updating hologram data. This method of modifying/updating the hologram data of one or more layers allows the one or more layers to compensate for error across all layers of the three-dimensional hologram. The hologram data for one or more layers is therefore updated based on the other layers which may increase the quality of the three-dimensional hologram, when displayed. It has been found that a single layer can be used to compensate for an error created when summing all layers, although in other examples the error may be shared or distributed across a plurality of layers.

In some examples, the image comprises a first layer and a second layer and generating hologram data for each layer comprises: generating first layer hologram data for the first layer and generating second layer hologram data for the second layer.

In some examples, updating the hologram data of at least one layer of the image based on the hologram data of the other layers of the image, comprises: generating combined hologram data by summing the first and second layer hologram data, generating constrained hologram data by applying a first constraint to the combined hologram data, determining a difference between the combined hologram data and the constrained hologram data, and updating the hologram data of at least the second layer of the image based on the difference.

In one example, updating the hologram data of the second layer, based on the difference, comprises: (i) generating error adjusted second layer hologram data for the second layer, based on: the difference and the second layer hologram data, (ii) converting the error adjusted second layer hologram data into error adjusted second layer image data, (iii) determining, from the error adjusted second layer image data, constraining data, (iv) generating constrained second layer image data based on: the constraining data and initial image data of the second layer, and (v) converting the constrained second layer image data into updated second layer hologram data. The same process can be applied to updating hologram data of the other layers. In some examples, the first constraint may be based on constraints of a spatial light modulator, SLM, used to display the CGH. In some examples, the first constraint may additionally or alternatively be to ensure that the combined hologram data has a constant amplitude.

In some examples, the method may comprise: iteratively updating the hologram data of the at least one layer based on the hologram data of the other layers, and for at least two iterations, displaying a three-dimensional hologram based on: the updated hologram data of the at least one layer determined during that iteration and the hologram data of the other layers.

In one example, updating the hologram data of at least one layer of the image based on the hologram data of the other layers of the image, comprises: updating the hologram data of only one layer of the image at any one time.

In some examples, the method further comprises displaying the hologram data, wherein the displaying the hologram data comprises using speckle reduction.

In some examples, the three-dimensional image comprising the plurality of two-dimensional image layers corresponds to a current frame of video data, the video data comprising a plurality of frames including the current frame and a previous frame, each of the plurality of frames being a three-dimensional image comprising a plurality of two-dimensional image layers. Accordingly, generating hologram data for each layer of the image comprises generating hologram data for each layer of the image of the current frame, and wherein updating the hologram data of at least one layer of the image based on the hologram data of the other layers of the image comprises updating the hologram data of at least one layer of the image based on the hologram data of the other layers of the image of the current frame.

In some examples, generating hologram data for each layer of the image comprises, for each image layer of the plurality of image layers: generating hologram data of the current frame using both: (i) image data of the current frame, and (ii) constraining data, wherein the constraining data is based on hologram data of the previous frame. In this method, the “image data of the current frame” corresponds to image data in a particular image layer of the current frame. The “hologram data of the current frame” therefore corresponds to hologram data in the particular layer of the current frame.

Thus, hologram data for the current frame is based on the previous frame. The current frame is therefore not constrained based on the random phase data, but rather constraining data determined/extracted from the previous frame. The method of modifying/updating the hologram data of one or more layers can therefore be used in conjunction with the method of generating hologram data of a particular frame based on constraining data determined/extracted from the previous frame. Together these techniques allow hologram data of a higher quality to be generated, with only minimal additional processing.

In some examples, the constraining data for each layer may be based on hologram data of at least one layer of the previous frame. In some examples, the constraining data may be based on hologram data for a corresponding layer of the previous frame. A “corresponding layer” may be a same layer in the previous frame and/or a different layer in the previous frame. A different layer may be appropriate when there is movement in depth between frames, for example.

The constraining data may comprise a two-dimensional array comprising constraining data for at least two layers. This can give more efficient storage and processing when the data is disjoint in the sense that any given non-zero pixel corresponds to image data for a single layer. In some cases, the entire hologram will be disjoint so that a single “global” array can be used for constraining data across all layers. In other examples only some data may be disjoint in this way (such as when transparency is present in the image), in which case two or more two-dimensional arrays may be provided and still give efficiency benefits compared to maintaining separate constraining data for each/every layer.

In some examples, the method further comprises: (i) generating hologram data for each layer of the image of the previous frame, and (ii) updating the hologram data of at least one layer of the image of the previous frame based on the hologram data of the other layers of the image of the previous frame.

In some examples, the method further comprises, for each image layer of the plurality of image layers of the previous frame, iteratively generating the hologram data of the previous frame using both: (i) image data of the previous frame, and (ii) second constraining data, the second constraining data being based on hologram data of a previous iteration, wherein the constraining data for the current frame corresponds to second constraining data determined during a final iteration of the previous frame. In this method, the “image data of the previous frame” corresponds to image data in a particular image layer of the previous frame. The “hologram data of the previous frame” corresponds to hologram data in the particular layer of the previous frame.

In some examples, the method further comprises, for each image layer of the plurality of image layers of the previous frame, iteratively generating the hologram data of the previous frame using both: (i) image data of the previous frame, and (ii) second constraining data, the second constraining data being based on hologram data of a previous iteration, and for at least two iterations, displaying a hologram for the previous frame based on the hologram data generated during that iteration. The hologram may be further based on the hologram data for the other image layers of the plurality of image layers of the previous frame.

In some examples, the constraining data is updated based on determined motion between the previous and current frames.

According to a second aspect of the present invention there is provided a method of generating a computer-generated hologram from video data comprising a plurality of frames. This can be used in isolation or in combination with the method of the first aspect. The method comprises generating hologram data of a current frame using both: (i) image data of the current frame, and (ii) constraining data, the constraining data being based on hologram data of a previous frame.

Video data can include any type of video data capable of being displayed. The video data may, in some examples, include a plurality of frames, where each frame comprises two-dimensional image data. In other examples, the frames may comprise three-dimensional images. These three-dimensional images may be separable into different layers of two-dimensional images, as will be explained below, or may be point-cloud data that can be processed into a plurality of two-dimensional image slices. The three-dimensional images may contain dynamic depth information.

In some examples, video data includes a sequence of uncorrelated images, such as a slide show.

In some examples, the constraining data is phase data. Thus, throughout this discussion, the phrase “constraining data” may be replaced by “phase data”. In some examples, the constraining data also includes amplitude data, as well as phase data. As will be explained, this constraining or phase data can be determined while processing a first frame and then used by the next frame as a starting point for processing this next frame.

In examples, the current frame is the frame currently being processed and may be displayed by the holographic display after the previous frame. In a particular example, the previous frame is the frame immediately before the current frame.

Accordingly, the method generates hologram data for the current (or subsequent) frame based on the previous frame. This is in contrast to prior iterative methods, such as Iterative Fourier Transform Algorithms (IFTAs), whereby each frame in the video is treated independently of the other frames.

Accordingly, in contrast to, for example a standard IFTA, the method of the first aspect instead generates hologram data for the current frame based on the previous frame. The current frame is therefore not constrained based on the random phase data, but rather constraining data determined/extracted from the previous frame. Subsequent frames therefore benefit from the result of the previous frame, which results in generating hologram data of a higher quality with only minimal additional processing. Each frame inherits data from a previous frame, thereby improving the image quality by iterating on the results of the previous frame. As video data can comprise video scenes of hundreds of frames, the effect is an iteration with each frame, so as each frame is displayed the effect of quantisation noise is further reduced. The resource requirements are lower than prior iterative methods, allowing the method to be implemented in less powerful hardware and/or with lower power consumption. While the most benefit is obtained within a scene of video data (so that the current frame benefits from the similarity to the previous frame), the method also works across scene changes because in that case the inherited phase data or constraining data from the previous frame functions as random phase data. However, in other examples the first frame of a new scene may use random phase data instead of constraining data from the previous scene.

In some examples, prior to generating the hologram data of the current frame, the method comprises: (i) converting image data of the previous frame into the hologram data of the previous frame, (ii) generating constrained hologram data by applying a first constraint to the hologram data of the previous frame, (iii) converting the constrained hologram data into second image data, and (iv) determining, from the second image data, the constraining data. In a particular example, determining, from the second image data, the constraining data, comprises: extracting from the second image data, the constraining data. As mentioned, this constraining data may be phase data. Generating the hologram data of the current frame then comprises: generating constrained image data for the current frame based on: the constraining data and initial image data of the current frame, and converting the constrained image data into the hologram data of the current frame. In one example, generating constrained image data for the current frame, comprises: applying the constraining data to the initial image data of the current frame.

The hologram data of the current frame is therefore based on the constraining data determined during processing of the previous frame, rather than, for example, being based on random phase data. The process can then be repeated for the next and further frames in the video data. For example, the hologram data of the current frame can undergo the same process as described in steps (ii)-(iv) to generate further constraining data for the next frame.

In some examples, where the previous frame is the first frame in a plurality of frames, step (i) is preceded by a step of generating the image data of the previous frame by applying random phase data to initial image data of the previous frame. Thus, it is only the first, initial frame in a video (or sometimes the first frame in a new scene) that is modified based on the random phase data, and all subsequent frames are modified based on the constraining data of the previous frame.

As will be described in more detail below, converting any image data into any hologram data, such as the image data of the previous frame (discussed in step (i)) may comprise performing an Inverse Fourier Transform on the image data. As an example, converting image data of the previous frame into the hologram data of the previous frame comprises performing an inverse Fourier Transform on the image data of the previous frame. Similarly, converting any hologram data into any image data, such as the constrained hologram data (discussed in step (iii)) comprises performing a Forward Fourier Transform on the hologram data. As an example, converting the constrained hologram data into second image data comprises performing a forward Fourier Transform on the constrained hologram data. It will be appreciated that the methods described herein are not limited to only Fourier Transforms, other forms of space-frequency transform can also be used.

In some examples, the first constraint may be a constraint based on constraints of a spatial light modulator, SLM, used to display the CGH. For example, generating constrained hologram data by applying the first constraint to the hologram data of the previous frame, may comprise: quantizing the hologram data based on constraints of a spatial light modulator. This may involve quantising hologram data values to pre-determined hologram values imposed by the type of SLM. Any suitable quantisation method can be used, including minimising the error to the quantised value, rounding up to the nearest allowable value, and rounding down to the nearest allowable value.

In a particular example, the method further comprises displaying a CGH for the current frame based on the hologram data of the current frame. In some examples, the hologram data is processed further before being displayed. For example, the hologram data may be first constrained by applying a first constraint to the hologram data.

In some examples, the hologram data may additionally or alternatively be digitally focused by applying a focus factor, such as by applying a parabolic phase function. This process is described in more detail in PCT patent application publication number WO2020/148521, which is incorporated herein by reference. The hologram data may additionally or alternatively be complex-added to other hologram data, such as hologram data corresponding to other layers in a three-dimensional image.

In one example, the method comprises: iteratively generating the hologram data of the previous frame using both: image data of the previous frame and second constraining data, the second constraining data being based on hologram data of a previous iteration. Accordingly, in some examples, the hologram data of the previous frame is iteratively determined, which improves the image quality of the hologram. In such a case, it is preferred that the constraining data for the current frame (i.e. the constraining data used to generate the hologram data of the current/next frame) corresponds to second constraining data determined during the final iteration of the previous frame. This means that the hologram data for the current/next frame is of a higher quality (which may avoid the need to iteratively process the current/next frame altogether, or at least reduce the number of iterations) because it is based on the final iteration of the previous frame. The hologram data of the current frame can also be iteratively generated, in some examples.

In one example, iteratively generating the hologram data of the previous frame comprises iteratively repeating, for the previous frame, the steps of: (i) converting image data of the previous frame into the hologram data of the previous frame, (ii) generating constrained hologram data by applying a first constraint to the hologram data of the previous frame, (iii) converting the constrained hologram data into second image data, (iv) determining, from the second image data, second constraining data, and (v) generating further constrained image data for the previous frame based on: the second constraining data and initial image data of the previous frame, wherein the further constrained image data forms the image data of the previous frame for the next iteration. In other examples, different iterative methods of generating hologram data of the previous frame can be used.

In some examples, no iterations are performed. In such a case, only steps (i)-(iv) are performed, and the constrained hologram data determined in step (ii) is output/displayed for the previous frame, rather than additionally constraining the image data of the previous frame, as in step (v). In other examples, only one iteration is performed (i.e. steps (i)-(v) are initially performed, then only steps (i) and (ii) are performed again based on the further constrained image data generated in step (v)). Thus, the constrained hologram data determined in the final step (ii) is output/displayed for the previous frame. Such methods reduce processing power because fewer (or no iterations) are performed.

In some examples, several iterations are performed, but the constrained hologram data determined in the first or one of the earliest iterations of step (ii) is output/displayed for the previous frame, despite further iterations producing further constrained hologram data. Such a method allows the hologram to be displayed with low latency, while the further iterations provide improved constraining data as a starting point for the next frame. In other examples, several iterations are performed, but the constrained hologram data determined in the final step (ii) is output/displayed for the previous frame. Such a method ensures that the displayed hologram is of the highest quality (improved by multiple iterations).

In some examples, the image data of the previous frame (from step (i)) has been produced by applying third constraining data to the initial image data of the previous frame, where the third constraining data is based on hologram data of a further previous frame (such as two frames before the current frame). Because of this, fewer iterations may be performed on each subsequent frame because they are based on previous frames, rather than random phase data.

In some examples, the method comprises iteratively generating the hologram data of the previous frame using both: image data of the previous frame and second constraining data, the second constraining data being based on hologram data of a previous iteration, and further comprises, for at least two iterations: displaying a hologram for the previous frame based on the hologram data generated during that iteration. Displaying two or more interim iterations (rather than just the final hologram data determined during the last iteration) means that even if the hologram data generated in the early iterations are very noisy, they only persist for a short time. In some examples, this also improves the perceived quality of the hologram because persistence of vision means that the viewer inherently applies an averaging process so that the initial noisy iterations are less noticeable. Thus, rather than only displaying a final iteration of hologram data, the method comprises displaying the interim hologram data while the iterative process is occurring.

In some examples, the concept of “Windowed IFTA” is used to display a higher quality hologram in a subset of the “full” Fourier domain. This sub-region (or “window”) has a higher quality because the noise is contained in a surrounding noise region (outside of the window). The most important part of the hologram is therefore perceived by a viewer to have a higher overall image quality, and the less important part is noisier. For example, the higher quality window may be the centre of the hologram, meaning that the noise is towards the edges of the displayed hologram. The window/sub-region may be known as a first region, in some examples, and the noise region may be known as a second region.

To achieve this, image data of a frame (and/or image data of an iteration) is generated differently in different regions of the image. For example, in cases where a frame is processed iteratively, rather than generating image data for each iteration based on the original/initial image data of the frame and phase/constraining data of a previous iteration (as described above), only a first region of the image data (the “window” area of interest) is generated in this way. A second region (the noise region) is instead based on reconstructed image data from the previous iteration. The net result of this is that the first region contains image data (and therefore hologram data) that is of a higher quality than it would be if the whole image was processed in this way. The image data (and hologram data) in the second region, is therefore noisier. Put another way, the IFTA only optimises the first region.

In addition, the image data for the frame (which can go on to being processed iteratively) can be generated based on the original/initial image data of the frame and phase/constraining data of the previous frame in the first region (the “window” area of interest). The second region (the noise region) is based on reconstructed image data from the previous frame. Again, this results in a higher quality image/hologram in the first region.

Accordingly, an example method comprises iteratively generating hologram data of a current frame using: (i) image data of the current frame, (ii) constraining data, the constraining data being based on hologram data of a previous iteration, and (iii) reconstructed image data of the previous iteration, the reconstructed image data being determined from the hologram data of the previous iteration, where a first region of the iteratively generated hologram data is based on the image data of the current frame and the constraining data of the previous iteration, and a second (different) region of the hologram data is based on the reconstructed image data of the previous iteration. In some examples, the second region of the hologram data is further based on a scale factor.

In some examples the method comprises generating hologram data of a current frame using: (i) image data of the current frame, (ii) constraining data, the constraining data being based on hologram data of a previous frame, and (iii) reconstructed image data of the previous frame, the reconstructed image data being determined from the hologram data of the previous frame, where a first region of the hologram data of the current frame is based on the image data of the current frame and the constraining data of the previous frame, and a second (different) region of the hologram data of the current frame is based on the reconstructed image data of the previous frame. In some examples, the second region of the hologram data is further based on a scale factor.

In some examples, hologram data is generated for multiple colour images for each frame. As such, the overall displayed hologram may be full colour, such as having red, green and blue holograms that combine to display a RGB hologram. Each frame may therefore have a plurality of images associated with the frame, each of the plurality of images representing a particular colour image.

In full colour holograms, the Field of View (FOV) for a phase-only SLM is proportional to the wavelength that it is illuminated by, because longer wavelengths are diffracted more than shorter wavelengths. It may therefore be useful to scale the green and red images so that their respective FOVs overlap with the FOV of the blue image, thereby using the blue FOV as the window to optimise. This results in a better image quality for green and red holograms. Thus, typically, the content from the longer wavelengths is scaled down to fit inside the FOV of the shortest wavelength, leaving some of the FOV unused.

Accordingly, in some examples, the method comprises scaling the hologram data and/or the image data of the current frame based on a wavelength of light used to illuminate an SLM of a holographic display. In some examples, the method comprises scaling the hologram data and/or the image data of the current frame based on a first wavelength of light used to illuminate an SLM of a holographic display and a further wavelength of light. In a specific example, the first wavelength is longer than the further wavelength. For example, the first wavelength may be associated with red or green light, and the further wavelength may be associated with blue light.

In some examples, the method comprises generating first hologram data of a current frame using: (i) first image data of the current frame, (ii) first constraining data, the first constraining data being based on first hologram data of a previous frame, and (iii) first reconstructed image data of the previous frame, the first reconstructed image data being determined from the first hologram data of the previous frame, where a first region of the first hologram data of the current frame is based on the first image data of the current frame and the first constraining data of the previous frame, and a second (different) region of the first hologram data of the current frame is based on the first reconstructed image data of the previous frame, wherein sizes/areas of the first and second regions are based on a first wavelength of light used to illuminate an SLM of a holographic display. The first image data and the first hologram data may correspond to a particular colour, the particular colour being associated with the first wavelength of light. In some examples, the sizes/areas of the first and second regions are based on the first wavelength of light used to illuminate an SLM of a holographic display and a further wavelength of light.

In a particular example, these method steps are repeated for second hologram data and second image data of the current frame (as well as second hologram data of the previous frame, and second reconstructed image data of the previous frame), where the second image data and the second hologram data may correspond to a second colour, the second colour being associated with a second wavelength of light. In some examples, the sizes/areas of the first and second regions are based on the second wavelength of light used to illuminate an SLM of a holographic display and a further wavelength of light. In a specific example, the first wavelength is longer than the further wavelength and the second wavelength is longer than the further wavelength. For example, the first wavelength may be associated with red light, the second wavelength may be associated with green light and the further wavelength may be associated with blue light.

In an example, hologram data for blue images are not scaled. That is, there is no second region when generating hologram data for third hologram data, where the third hologram data corresponds to a third colour, the third colour being associated with a third wavelength of light.

Where the current and previous frames each comprise a plurality of two-dimensional image layers (which form three-dimensional image frames), the method may comprise: generating hologram data for each layer of the current frame, wherein the constraining data for each layer is based on hologram data of a corresponding layer of the previous frame, and updating the hologram data of at least one layer of the current frame based on the hologram data of the other layers of the current frame. The hologram data for one or more layers is therefore updated based on the other layers to ensure that the three-dimensional hologram, when displayed, is of high quality. It has been found that a single layer can be used to compensate for an error created when summing all layers, although in other examples the error may be shared or distributed across a plurality of layers. In addition, by using the constraining data from a corresponding layer in the previous frame, the hologram data of the current frame will be based on the most relevant constraining data, since image data from corresponding layers of adjacent frames will be closely related. In other words, the benefit of iterating between frames is achieved and is compensated for by updating one layer based on the hologram data of layers of the current frame.

In the following example, the previous and current frames comprise two layers, although it will be appreciated that the frames may comprise any number of layers, and different frames may even comprise a different number of layers. The following example may therefore be extended to three or more layers. Accordingly, in some examples, generating hologram data for each layer of the current frame comprises: generating first layer hologram data for a first layer of the current frame using both: image data of the first layer of the current frame and first layer constraining data, the first layer constraining data being based on first layer hologram data of the previous frame. The method further comprises: generating second layer hologram data for a second layer of the current frame using both: image data of the second layer of the current frame and second layer constraining data, the second layer constraining data being based on second layer hologram data of the previous frame. In certain examples, updating the hologram data of at least one layer of the current frame based on the hologram data of the other layers of the current frame, comprises: generating combined hologram data by summing the first and second layer hologram data, generating constrained hologram data by applying a first constraint to the combined hologram data, determining a difference between the combined hologram data and the constrained hologram data and updating the hologram data of at least the second layer of the current frame based on the difference. In some examples, the first constraint may be based on constraints of a spatial light modulator, SLM, used to display the CGH (such as phase quantisation constraints of the SLM). In some examples, the first constraint may additionally or alternatively be to ensure that the combined hologram data has a constant amplitude, or preferably an identical amplitude profile to the light illuminating the SLM.

An image layer (like those described above) comprises data, such as complex data, representing a portion of a three-dimensional image/object at a particular depth. The data may be in the form of an array, in certain examples. An image layer may alternatively be known as a complex layer, an object layer, or a layer in some examples.

In some examples, the process of updating the hologram data for the at least one layer can be repeated iteratively to improve the quality of the hologram data. Accordingly, the method may comprise: iteratively updating the hologram data of the at least one layer based on the hologram data of the other layers of the current frame, and for at least two iterations, displaying a three-dimensional hologram for the current frame based on: the updated hologram data of the at least one layer and the hologram data of the other layers. In addition to the benefit provided by the iterative steps, displaying the interim iterations (rather than just the final hologram data determined during the last iteration) improves the perceived quality of the hologram in the same way as discussed above.

In one example, updating the hologram data of at least one layer based on the hologram data of the other layers comprises: updating the hologram data of only one layer of the current frame at any one time. For example, the hologram data of one layer may be updated based on the other layers during a first iteration, and then the hologram data of the same layer (or another layer) may be updated based on the other layers during a second iteration. During any single “update” process, only one layer is being updated (even if other layers of the same frame are updated at a later time). It has been found by the inventors that one layer of the hologram can be updated to compensate for all other layers in the image, without reducing image quality, and separately updating the layers reduces the processing time because parallel updates are not being made for the other layers. The other layers may be updated separately at a later time.

In some cases, the inventors have found that much of the difference between successive video frames is due to movement of objects within the frame, such as from movement of the object or from a change of viewing position. For example, in video, objects move within the frame or possibly the whole frame moves during panning. In another example, in a head-mounted display, movement of the head produces a change in the position of objects within the displayed image as the viewpoint changes. Motion of elements from frame to frame image reduces the effectiveness of the previous frame as a starting point for the calculation of the next frame, although it is still an improvement on random phase data as used previously. Accordingly, in some examples, the constraining data is updated based on determined motion between the previous and current frames. The hologram data of the current frame may be based on a determined motion of displayed image portions between the previous and current frames. For example, the method may further comprise: (i) modifying the constraining data based on motion of the image between the previous and current frames, to generate modified constraining data, and (ii) generating hologram data of the current frame using the modified constraining data. Accordingly, this inter-frame motion may be calculated and used to modify the constraining data, thereby improving the quality of the hologram determined for the next frame. This may reduce (or avoid altogether) the number of iterations required while processing the frame.

According to a third aspect of the present invention there is provided a method of displaying a computer-generated hologram from an image, the method comprising: (i) iteratively generating hologram data of the image using both: image data and constraining data, the constraining data being based on hologram data of a previous iteration, and (ii) for at least two iterations, displaying a hologram of the image based on the hologram data generated during that iteration.

The method of the third aspect improves the quality of the hologram being displayed by displaying holograms based on the interim hologram data being generated during the iterative process. Thus, rather than only displaying the final, iterated or converged hologram data determined after a particular number of iterations, the method comprises displaying the interim hologram data while the iterative process is occurring. While the first few displayed holograms will be of a lower quality than the later displayed holograms, these are only displayed for a short time. In some examples, persistence of vision applies an averaging process so that the initial noisy iterations are less noticeable and a viewer will perceive a faster increase in image quality as a result.

In one example, the image data corresponds to, or is based on, initial image data of the image. For example, the method may further comprise, before iteratively generating the hologram data: generating the image data by applying random phase data to the initial image data.

In an example, iteratively determining the hologram data of the image, comprises iteratively repeating the steps of: (i) converting the image data into hologram data, (ii) generating constrained hologram data by applying a first constraint to the hologram data, (iii) converting the constrained hologram data into second image data, (iv) determining, from the second image data, the constraining data, and (v) generating constrained image data based on: the constraining data and the initial image data, wherein the constrained image data forms the image data for the next iteration. Other examples of iteratively determining the hologram data may alternatively be used.

In one example, the method comprises: for every iteration, displaying a hologram of the image based on the hologram data generated during that iteration. By displaying a hologram every iteration the averaging effect to reduce noise is increased, making the noise even less noticeable.

In a particular example, the image corresponds to a previous frame of video data comprising a plurality of frames, and the method further comprises: generating hologram data of a current frame using both: image data of the current frame; and second constraining data, the second constraining data corresponding to constraining data determined during the final iteration of the previous frame. In a particular example, the image (and all frames of the video data, if applicable), comprises two-dimensional image data.

All of the above-mentioned aspects relate to software or algorithmic approaches to reduce quantisation or holographic speckle. In examples, any of these aspects (with or without the other features also described) can be combined with displaying the resulting hologram data using hardware-based speckle reduction, such as a vibrating element or a rotating rough surface in the optical path. Such hardware-based speckle reduction tends to introduce blur and reduce resolution but may be applied at a lower intensity with the above-mentioned aspects to retain more resolution because the appearance of speckle has already been reduced. In other examples, speckle reduction of any type may be additionally or alternatively used, including software-based speckle reduction.

In a fourth aspect of the present invention there is provided a holographic display for displaying a computer-generated hologram, CGH, comprising: an illumination source configured to emit at least partially coherent light, a spatial light modulator, SLM, and a controller configured to implement a method according to any of the aspects/methods described above or herein.

In a fifth aspect of the present invention there is provided a holographic display for displaying a computer-generated hologram, CGH, comprising: an illumination source configured to emit at least partially coherent light, a spatial light modulator, SLM, and a controller configured to generate hologram data of a current frame using both: image data of the current frame and constraining data, the constraining data being based on hologram data of a previous frame, and operate the SLM to display a hologram of the current frame based on the hologram data of the current frame.

In some examples, the controller is further configured to: iteratively generate the hologram data of the previous frame using both image data of the previous frame and second constraining data, the second constraining data being based on hologram data of a previous iteration, and for at least two iterations, operate the SLM to display a hologram of the previous frame based on the hologram data generated during that iteration.

The controller may further be configured to implement any other method steps described above in respect of the first, second or third aspects.

In a sixth aspect of the present invention there is provided a holographic display for displaying a computer-generated hologram, CGH, from a three-dimensional dimensional image comprising a plurality of two-dimensional image layers. The holographic display comprises: an illumination source configured to emit at least partially coherent light, a spatial light modulator, SLM, and a controller configured to: generate hologram data for each layer of the image, update the hologram data of at least one layer of the image based on the hologram data of the other layers of the image, and operate the SLM to display a hologram of the three-dimensional image based on: the updated hologram data of the at least one layer and the hologram data of the other layers.

In some examples, the controller is further configured to: iteratively update the hologram data of the at least one layer based on the hologram data of the other layers and for at least two iterations, operate the SLM to display a hologram of the three-dimensional image based on: the updated hologram data of the at least one layer determined during that iteration, and the hologram data of the other layers.

The controller may further be configured to implement any other method steps described above in respect of the first, second or third aspects.

In a seventh aspect of the present invention there is provided a holographic display for displaying a computer-generated hologram, CGH, comprising: an illumination source configured to emit at least partially coherent light, a spatial light modulator, SLM, and a controller configured to: iteratively generate hologram data of the image using both: image data and constraining data, the constraining data being based on hologram data of a previous iteration, and for at least two iterations, operate the SLM to display a hologram of the image based on the hologram data generated during that iteration.

The controller may further be configured to implement any other method steps described above in respect of the first, second or third aspects.

In an eighth aspect of the invention, there is provided a computer program comprising instructions that, when executed by a controller of a holographic display, instruct the controller to carry out the method of any of the first, second and third aspects. The computer program may be embodied as a non-transitory computer-readable medium comprising computer-executable instructions.

In a ninth aspect of the invention, there is provided a processing system configured to implement the method of any of the first, second and third aspects. Example processing systems include general computing processors (such as a CPU), graphics processing units (GPUs), Field Programmable Gate Arrays (FPGAs), Application Specific Integrated Circuits (ASICs) and programmable Digital Signal Processors (DSPs).

Further features and advantages of the invention will become apparent from the following description of preferred embodiments of the invention, given by way of example only, which is made with reference to the accompanying drawings.

### BRIEF DESCRIPTION OF THE DRAWINGS

FIG. 1 is a diagrammatic representation of an example holographic display;

FIG. 2A is an example representation of hologram data;

FIG. 2B is an example representation of phase/hologram data achievable by an example SLM;

FIG. 2C is an example representation of constrained/quantized hologram data;

FIG. 3A is an example flow diagram illustrating an example method of generating hologram data for a first/initial frame of video data;

FIG. 3B is an example flow diagram illustrating an iterative example method of generating hologram data for a first/initial frame of video data;

FIG. 4A is an example flow diagram illustrating an example method of generating hologram data for a second/subsequent frame of video data;

FIG. 4B is an example flow diagram illustrating an iterative example method of generating hologram data for a second/subsequent frame of video data;

FIG. 4C is an example flow diagram illustrating an iterative example method of generating hologram data for a second/subsequent frame of video data using windowed IFTA;

FIG. 4D is an example representation of coloured holograms, two of which are scaled based on their wavelengths;

FIG. 5A is an example flow diagram illustrating an example method of generating three-dimensional hologram data for a first/initial frame of video data;

FIG. 5B is an example flow diagram illustrating an example method of generating three-dimensional hologram data for a second/subsequent frame of video data; and

FIG. 6 is an example flow diagram illustrating an example method of generating and displaying hologram data for a two-dimensional image.

### DETAILED DESCRIPTION

System for Use with Examples

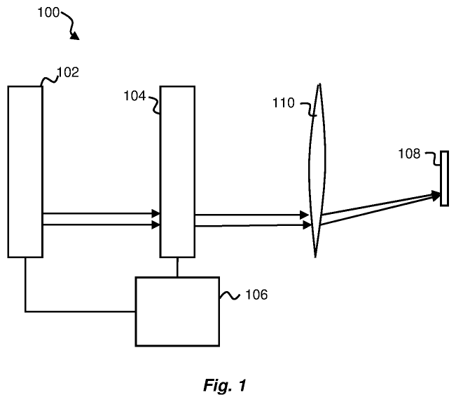

FIG. 1 depicts an example holographic display 100. The display 100 includes an illumination source 102 configured to emit at least partially coherent light. In this example, the illumination source 102 is a single light emitter, in this case a laser, that emits light rays towards a spatial light modulator, SLM, 104. In other examples, the illumination source 102 comprises a plurality of light emitters which together illuminate the SLM 104. The display 100 further comprises a controller 106, that receives an image or a series of image frames in the form of a video, that is/are to be converted into a format capable of being interpreted by the SLM 104 in order to generate a hologram in a viewing plane 108. The controller 106 therefore converts image data into hologram data and the SLM 104 is then controlled based on this hologram data. Image data (indicative of the image or image frame or image layer) may be received by the controller 106 from memory within the display 100, a storage medium associated/coupled with the display 100, or from a separate device in communication with the display 100, such as via an HDMI, DisplayPort, Thunderbolt or USB-C interface. The image data is typically uncompressed when received over such interfaces. If the image data is compressed, then it is decompressed before display.

The SLM 104 of this example comprises an array of pixels/elements. A voltage/bias can be applied to each element individually to control the phase and/or amplitude modulation of a light ray as it passes through the element by an amount based on the voltage applied to the element through which the light ray has passed. Accordingly, in some examples, the controller 106 also controls the voltages applied to each pixel/element of the SLM 104. However, in other examples, a separate controller, such as a controller within or communicably coupled to the SLM 104 interprets the hologram data (representing the phase modulation required to generate the hologram) and responsively controls the voltages applied to each element of the SLM. In some examples, the controller 106 also controls operation of the illumination source 102, such as to control a required intensity of the illumination source.

In this example, the display further comprises a Fourier lens 110 which focuses the light from the SLM 104 to a viewing plane 108. Accordingly, light rays, emitted by the illumination source 102, travel from the illumination source 102 to the SLM 104, through elements of the SLM 104, from the SLM 104 to the lens 110 and from the lens 110 towards a viewing plane 108. The light rays therefore follow an optical path along an optical axis, from the illumination source 102 towards the eye of an observer that is viewing the holographic display 100. FIG. 1 shows two example light rays as they travel from the illumination source 102 and are focused at the viewing plane 108.

It should be noted that the schematic depiction in FIG. 1 is to aid understanding, and the skilled person will be aware that numerous variations can be used in conjunction with the methods described herein. For example, FIG. 1 depicts a linear arrangement of the holographic display component, but other arrangements may include image folding or directing components so that the optical path has a different shape, such as a folded optical path as described in international patent application no. PCT/EP2021/05162, incorporated herein by reference. Similarly, although a transmissive SLM is depicted, the person skilled in the art will understand that a reflective SLM can also be used.

### Quantisation for Display Reduces Image Quality

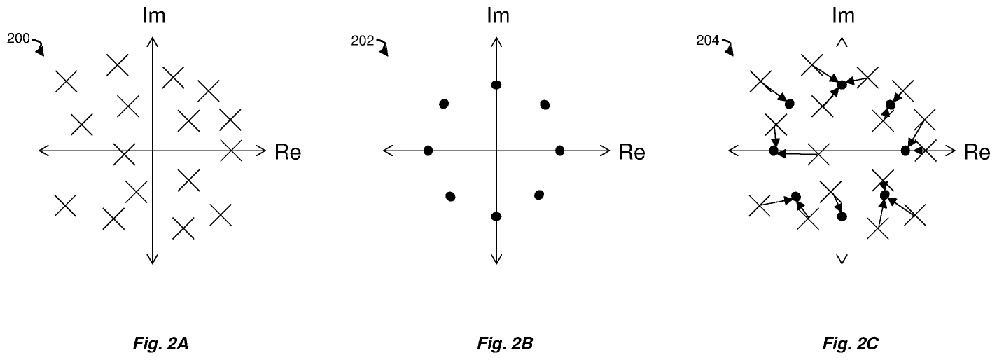

As mentioned, in holographic displays, the initial calculation of CGH data for display assumes that there is no limit on what can be displayed: phase modulation is available across the full range of 0 to a radians together with amplitude modulation, so that both a particular phase and amplitude can be reproduced. FIG. 2A depicts an example phasor diagram representing example hologram data. Each “cross” corresponds to the combination of amplitude and phase modulation to be provided by a particular element of the SLM 104. The phase modulation of the light ray is given by the azimuthal angle between the positive real axis and an imaginary line drawn from the origin to the centre of the cross.

FIG. 2B depicts the phase modulation values achievable by an example SLM. Here the SLM is capable only of phase modulation and has eight modulation states, corresponding to phases of 0, π/4, π/2, 3π/4, π, −π/4, −π/2, and −3π/4, and so is unable to provide the desired modulation values shown in FIG. 2A. As a result the CGH data is quantised for display, such as by minimising an error between the desired value and the quantised value. FIG. 2C depicts how the hologram data depicted in FIG. 2A might be quantized based on the constraints of the SLM of FIG. 2B. As shown in FIG. 2C several of the original hologram data points in FIG. 2A now lie on top of each other, because separate points in FIG. 2A may be quantised to the same value. This lowers the quality of the displayed hologram by reducing contrast and/or introducing noise. This is because the quantisation procedure introduces an error which is the difference between the ideal point of FIG. 2A and the quantised value of FIG. 2C.

As is well known, the displayed hologram on the SLM is in a different domain than that which is viewed at the viewing plane 108. In this example, the image at a viewing plane 108 is an inverse Fourier transform of the SLM display because of the action of the lens 110. This conversion between domains means, every element of the perceived image depends on every element of the image formed by SLM 104. Accordingly, changing the phase modulation of one value in the hologram data therefore impacts every point in the resultant image. Iterative techniques, such as the Iterative Fourier Transform Algorithms (IFTAs) to apply a further constraint in the visual domain, further constrain the result in the Fourier domain, and so on to converge on a higher quality hologram for display.

However, such iterative methods require many iterations, perhaps as many as 100, to produce a high quality image. As a result, it can take a noticeable time before a CGH is ready for display and/or significant computational resources are required. This is true for “static” data, such as heads-up display, that potentially displays slowly changing data, such as an information overlay, because calculating the iterations takes time that can result in a delay, possibly causing a display to appear unresponsive. It is also true for video data, where calculation of each video frame using iterative methods at a reasonable frame rate can require significant processing resources, increasing power consumption and inhibiting miniaturisation.

The inventors have developed improved algorithms that can increase perceived quality with a generally lower requirement for computational resources. As will be explained, in the case of video data, the algorithms of this disclosure generate hologram data for a particular frame of video data based on a “seed”, where this seed is determined from hologram data of the previous frame. This “seed” (or constraining or phase data, as it is described herein) is a function of the previous video frame.

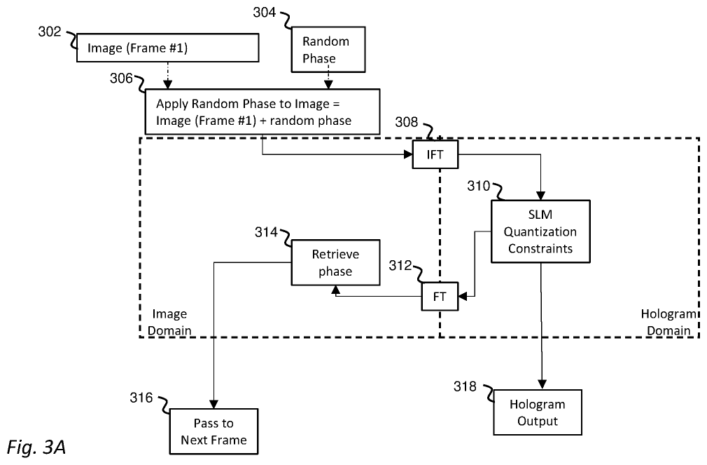

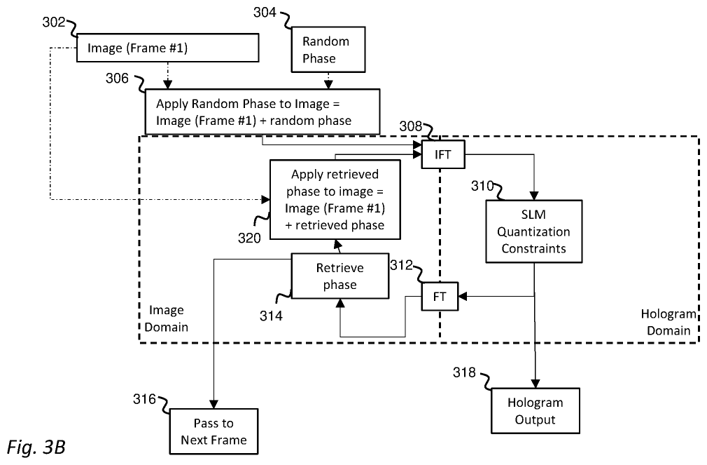

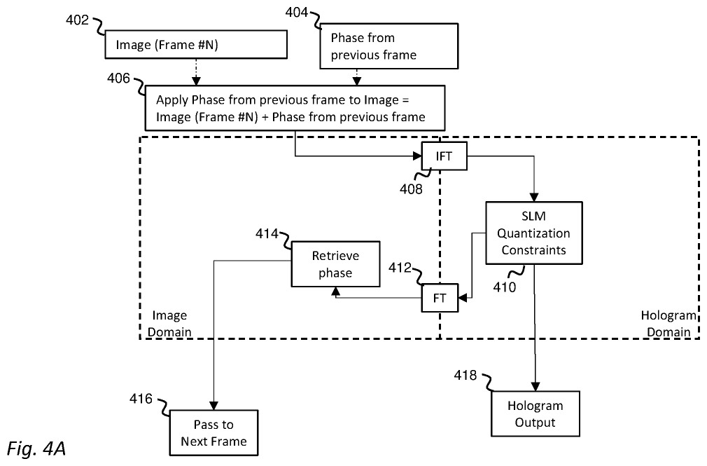

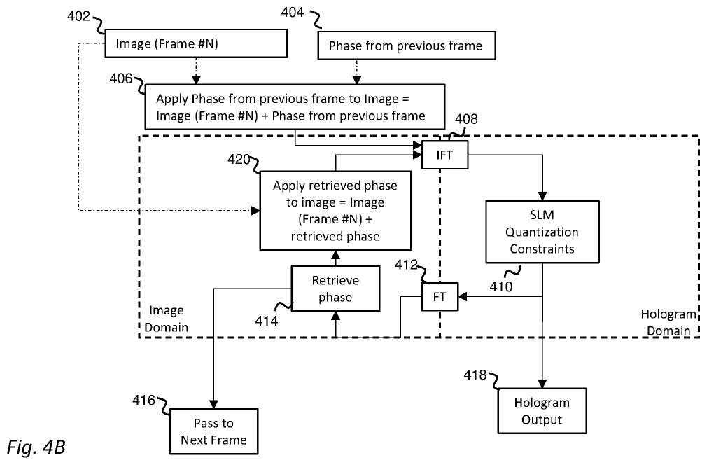

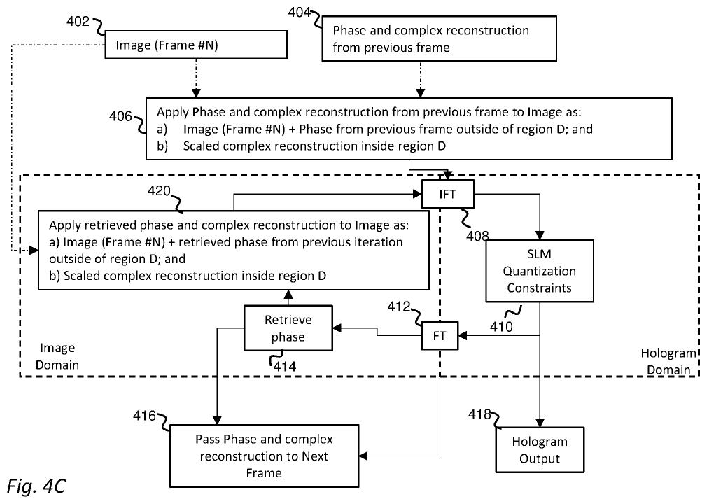

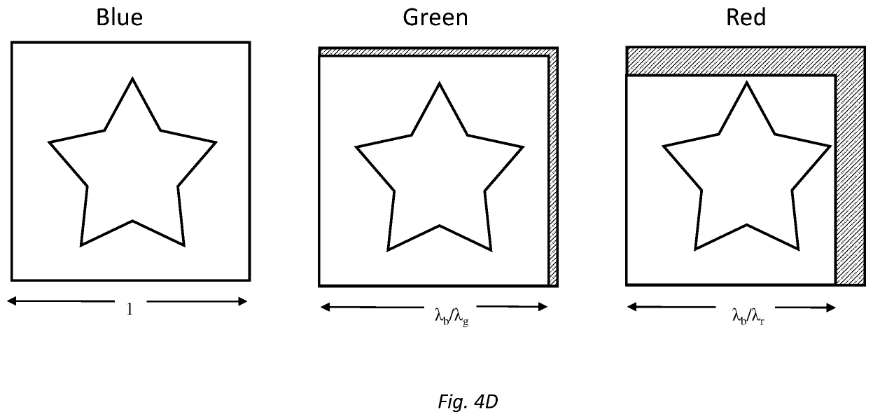

FIGS. 3A, 3B, 4A and 4B depict example flow diagrams of methods of generating holograms from video data comprising a plurality of frames. FIGS. 3A and 3B depict example processes for a first frame of the video data and FIGS. 4A and 4B depict example processes for a second frame (and subsequent frames) of the video data. The steps depicted in FIGS. 3A, 3B, 4A and 4B may be embodied in a computer program, such as on a computer-readable medium, and be carried out by one or more controllers, such as controller 106 discussed in connection with FIG. 1.

### Example Method for Improving Image Quality of Between Frames of Video Data

Referring to FIG. 3A, the method begins by obtaining/receiving initial image data of the first frame of the video data, as shown in block 302. The image data represents an entire scene for display as a hologram, for example it may be a substantially uncompressed frame earlier determined or received over an external interface, such as HDMI, DisplayPort, USB-C and Thunderbolt.

At block 304, random or pseudo-random phase data is generated or received.

At block 306, the initial image data from block 302 is modified by applying the random phase data from block 304 to generate image data.

In block 308, the image data produced in block 306 is converted into hologram data. In this example, this conversion comprises performing an Inverse Fourier Transform on the image data to produce/generate the hologram data. The image data of the first frame has therefore been converted from the image domain/space into the hologram domain/space via the Inverse Fourier Transform. In some examples, the hologram domain is also known as the Fourier domain.

In block 310, the hologram data is quantized/constrained by applying a constraint (or constraints) to the hologram data, thereby to produce constrained hologram data. As discussed, the constraint(s) are based on the constraints of the SLM used to display the hologram, for example quantizing the hologram data to values that can be modulated by the SLM.

In block 312, the constrained hologram data is converted back into image data. This is different to the image data produced in block 306 due to the constraints applied in block 310. This essentially “reconstructs” the image, but in modified form. In this example, this conversion comprises performing a Forward Fourier Transform on the constrained hologram. The constrained hologram data of the first frame has therefore been converted from the hologram domain back into the image domain via the Forward Fourier Transform. This simulates the result of displaying the quantised data from block 310 via the SLM and a lens.

In block 314, constraining data is determined from the second image data produced in block 312. In this example, the constraining data is phase data that has been extracted/retrieved from the second image data. It will be noted that the constraining data is different to the random phase data received/generated in block 304 due to the SLM quantization constraints applied in block 310.

Meanwhile, block 318 comprises outputting the constrained hologram data for the first frame for display by the SLM 104. In some examples, the constrained hologram data is processed further before being displayed by the SLM 104. For example, the constrained hologram data may be digitally focused by applying a focus factor, such as by adding a parabolic phase function (which is equivalent to the Fresnel Transform).

Examples of the mathematical operations in Blocks 306-314 will now be discussed. The skilled person will be aware alternative methods and domains exist, and the methods described herein are not limited to this specific example. For example, in block 306, uniformly distributed random phase data ϑ_{rnd} is added to the initial image data, I, to produce image data T in the following way:

T(u,v)=\sqrt{I(u,v)}e^{iϑ}^{_{rnd}}^{(u,v)}
where u and v are the coordinates in the image plane.

In block 308, the image data is converted into hologram data, H, via the Inverse Fourier Transform:

H(x,y)=F⁻¹{T(u,v)}
where x and y are the coordinates in the hologram plane.

In block 310, the hologram data is quantized to produce constrained hologram data H_{quant}:

H_{quant}(x,y)=QuantizeHologram(H(x,y))

Any suitable quantisation algorithm can be used, such as to minimise error between the original and quantised value. Some examples may use a lookup table for the quantisation.

In block 312, the constrained hologram data is converted into second/reconstructed image data, T_{rec}, via the Forward Fourier Transform:

T_{rec}(u,v)=F{H_{quant}(x,y)}

In block 314, the constraining data, phase data in this example, ϑ_{rec} is retrieved from the second image data:

ε_{rec}(u,v)=∠T_{rec}(u,v)

As mentioned above, unlike prior IFTA, the constraining data determined in block 314 is then used to constrain initial image data of the next or subsequent frame in the video data, in place of the random phase data at block 304. Accordingly, the process then proceeds to FIG. 4A, where the process steps of FIG. 3A are repeated but instead of applying random phase data, the constraining data determined in block 314 is used to constrain/modify the initial image data of the second frame. Accordingly, block 316 of FIG. 3A shows the constraining data being passed to the next frame.

FIG. 4A therefore begins by obtaining/receiving initial image data of the second frame of the video data, as shown in block 402. The second frame may be referred to as the current frame, and the first frame may then be referred to as the previous frame.

In block 404, the constraining data from the previous frame (i.e., the first frame) is received. As discussed, this constraining data is the phase data determined in block 316. Next, in block 406, the initial image data of the second frame is modified by applying the constraining data to the initial image data of the second frame to generate image data. In another example, the constraining data not only includes the phase; amplitude information can also be used from the previous frame. The amplitude information may, in some examples, be the amplitude of the previous frame. In other examples, the amplitude may be a random amplitude. The choice of whether to use the random amplitude or the previous amplitude may be based on a comparison of the current frame and the previous frame. In this way, the output of the previous frame forms a seed which is combined with the image data of the current frame.

In block 408, the image data produced in block 406 is converted into hologram data of the second frame. In this example, this conversion comprises performing an Inverse Fourier Transform on the image data to generate the hologram data of the second frame. Accordingly, the hologram data of the second frame is generated using both: image data of the second frame (which is based on initial image data of the second frame), and constraining data determined while processing the previous frame.

In block 410, the hologram data is quantized/constrained by applying a constraint (or constraints) to the hologram data, thereby to produce constrained hologram data.

In block 412, the constrained hologram data is converted back into image data. In this example, this conversion comprises performing a Forward Fourier Transform on the constrained hologram data to produce the (second) image data.

In block 414, further constraining data is determined from the second image data produced in block 412. Again, it will be noted that the further constraining data is different to the constraining data received in block 404 because it is based on both the current image frame and the SLM quantization constraints applied in block 410.

In the same way as discussed for block 318, at block 418 the quantised hologram data is output.

Blocks 406-414 can again be represented mathematically, for example, in block 406, the constraining data from the previous frame ϑ_{N-1} is added to the initial image data of the current frame, I, to produce image data T in the following way (these blocks are similar to blocks 306-314, and the further explanation of those blocks is not repeated here for clarity):

T(u,v)=\sqrt{I(u,v)}e^{iϑ}^{_{N−1}}^{(u,v)}

In block 408, the image data is converted into hologram data, H, via the Inverse Fourier Transform:

H(x,y)=F⁻¹{T(u,v)}

In block 410, the hologram data is quantized to produce constrained hologram data H_{quant}:

H_{quant}(x,y)=QuantizeHologram(H(x,y))

In block 412, the constrained hologram data is converted into second/reconstructed image data, T_{rec}, via the Forward Fourier Transform:

T_{rec}(u,v)=F{H_{quant}(x y)}

In block 414, the constraining data or phase data, ϑ_{rec,N} is retrieved from the second image data:

ϑ_{rec,N}(u,v)=∠T rec(u,v)

As for the first frame, this constraining data can again be passed to the next frame. Accordingly, block 416 shows the constraining data being passed to the next frame. The process continues again for the remaining frames in the video data such that blocks 406-416 (and potentially 418) are repeated for every subsequent frame.

FIGS. 3A and 4A therefore describe a process of generating hologram data of a second/current frame using constraining data based on hologram data of a first/previous frame. It has been found that this method provides improved image quality over using random phase to calculate the hologram for each frame, as was the case previously. A scene of video data typically comprises many hundreds of frames (for example a 30 s scene of video data at 50 frames per second has 1,500 frames). By using this method, iterative processing occurs between frames, rather than within them. The method requires minimal additional resource to extract the previous frame's phase and use this rather than generating random phase each frame. As a result, the quality of the displayed video will converge during the scene, improving video quality.

Some examples may apply motion tracking principles to further improve image quality to account for changes from frame to frame. For example, when panning is detected between frames, the extracted phase data may be translated accordingly before being added to a subsequent frame.

Example Method of Improving Quality within a Video Frame or Static Image

In both FIGS. 3A and 4A, there is no iteration being performed within each frame. FIG. 3B depicts an alternative process to that of FIG. 3A, and FIG. 4B depicts an alternative process to that of FIG. 4A. As will be discussed, the method is similar, but additionally contains iteration within each frame that occurs before the constraining data is passed to the next frame. These methods can further improve image quality when there are sufficient computing resources and/or available power for additional iterations before a next frame is required to be displayed.

FIG. 3B therefore depicts the same blocks as depicted in FIG. 3A, but with an additional block 320 to provide iteration within each frame. Here, after the constraining data has been determined in block 314, the initial image data received/obtained in block 302 is constrained again using the constraining data determined in block 314. The process is therefore similar to step 406 in FIG. 4A but using the initial image data of the first frame. Accordingly, in block 320, the initial image data of the first frame is modified/constrained by applying the constraining data to the initial image data of the first frame to generate constrained image data. For example, in block 320 the amplitude values of the image data are re-constrained to the original amplitude values of the initial image data (which has no phase), keeping the retrieved phase from block 314. The constrained image data generated in block 320 then forms the image data for block 308. Accordingly, from here, block 308 is performed again using the constrained image data generated in block 320 rather than the image data generated in block 306. Blocks 310, 312, 314 and, possibly, 318 are repeated again such that one full iteration has occurred (k=1). In FIG. 3A, it may be said that no iterations have occurred (k=0) because the initial image data was never constrained based on the constraining data determined in block 314. This iterative process helps converge on hologram data that differs from the constrained hologram data to a lesser degree, and it will be understood that the quality of the output hologram (in block 318) improves with each iteration. Steps 308, 310, 312, 314 and 320 may be repeated any desired number of times (k>1), however, the inventors have found that a good increase in quality may be obtained using this method by performing only one iteration k=1. It will be appreciated that the constraining data retrieved in step 314 after each iteration will likely differ from the constraining data retrieved from a previous iteration.

Block 318 is not necessarily required to output hologram data for every iteration. For example, the output and hence block 318 may occur only on a final iteration. Some examples may output the result of every iteration, with a suitably responsive display. In that case, image quality can be further improved over time by outputting each iteration because the eye will average the noise between iterations and further observe the convergence on the higher quality final iteration. Similarly, some of the iterations and not others may be output at block 318, such as every second, every third, every fourth or every fifth iteration. Alternatively iterations may be displayed at a maximum response rate of the display, if that is higher than the frame rate of the video data.

Regardless of how many iterations are performed, it is preferred that the constraining data passed to the next frame in block 316 is the constraining data determined from the final iteration (i.e., the last time block 314 is performed). This produces a more optimal input for the next frame, which should improve the quality of the hologram of the next frame, therefore improving the initial hologram output of the next frame, compared to using data of an earlier iteration.

Block 320 can also be represented mathematically, for example, here the constraining data ϑ_{rec,K-1} from block 314 is added to the initial image data of the first frame, I, to produce image data T_{K} for the next iteration K in the following way:

T_{K}(u,v)=\sqrt{I(u,v)}e^{iϑ}^{_{rec,K−1}}^{(u,v)}

In a similar way as for FIG. 3B, FIG. 4B shows a modification to the process of FIG. 4A by including internal iteration within a frame period which occurs before the constraining data is passed to the next frame.

FIG. 4B therefore depicts the same blocks as depicted in FIG. 4A, but with an additional block 420. In the same way as described in FIG. 3B, after the constraining data has been determined in block 414, the initial image data received/obtained in block 402 is constrained again using the constraining data determined in block 414. Accordingly, in block 420, the initial image data of the second frame is modified/constrained by applying the constraining data to the initial image data of the second frame to generate constrained image data. The constrained image data generated in block 420 then forms the image data for block 408. Accordingly, from here, block 408 is performed again using the constrained image data generated in block 420 rather than the image data generated in block 406. Blocks 410, 412, 414 and, possibly, 418 are repeated again such that one full iteration has occurred (k=1). In FIG. 4A, it may be said that no iterations have occurred (k=0). Steps 408, 410, 412, 414 and 420 may be repeated any desired number of times (k>1).

In the same way as described for FIG. 3B, regardless of how many iterations are performed, it is preferred that the constraining data passed to the next frame in block 416 is the constraining data determined from the final iteration (i.e. the last time block 414 is performed).

In some examples, the hologram data (or the constrained hologram data) for each frame is output (in blocks 318, 418) and displayed every iteration. Although the first few iterations will produce hologram data that results in a hologram with relatively high noise, the later iterations will produce holograms with less noise as the solution converges. As discussed, the eye/brain of the observer can apply an averaging process when these interim holograms are displayed such that the hologram is perceived as less noisy, despite early “versions” of hologram being displayed. In some examples, a hologram is displayed less often than for every iteration. For example, a hologram may be displayed for every other iteration that is performed. The rate at which iteration results are displayed may be based on the response rate of the display technology, for example. Other examples are also possible.

### Example Methods of “Windowed IFTA”

In some examples, the concept of “Windowed IFTA” can be used to display a higher quality hologram in a subset of the “full” Fourier domain. This sub-region (or “window”) has a higher quality because the noise is contained in a surrounding region (outside of the window). The most important part of the hologram is therefore perceived by a viewer to have a higher overall image quality, and the less important part is noisier. For example, the higher quality window may be the centre of the hologram, meaning that the noise is towards one or more edges/sides of the displayed hologram.

FIG. 4C depicts a modified version of FIG. 4B to achieve an adaptation of this “Windowed IFTA”.

In contrast to FIG. 4B, block 404 of FIG. 4C also comprises receiving the complex reconstruction (both phase and amplitude) T_{rec,N-1}(u, v) from the previous frame, as well as the constraining data, ε_{rec,N-1}(u, v) from the previous frame. For example, T_{rec,N-1}(u, v) corresponds to the reconstructed image data obtained in block 312 of FIG. 3A or 3B and the constraining data, ϑ_{rec,N-1}(u, v) corresponds to the constraining data passed to the next frame in block 316 of FIG. 3A or 3B. FIGS. 3A and/or 3B may therefore contain an additional block of passing the reconstructed image data to the next frame.

In block 406 of FIG. 4C, in contrast to FIG. 4B, the initial image data of this frame is modified depending upon whether the pixel (having a coordinate (u, v)) is within the window or is within the noise region. This “noise region”, D, is a region in which the image, I, will not overlap (and instead a scaled copy of the complex reconstruction of the previous frame, T_{rec,N-1}, is passed on). In an example, the window region is referred to as a first region of the image/hologram, and the noise region, D, is referred to as a second region of the image/hologram.

As such, in block 406, constrained image data is determined in the following way:

$$T ( u , v ) = \{ \begin{matrix}\sqrt{I ( u , v )} {e}^{i {ϑ}_{rec , N - 1} ( u , v )} & if ( u , v ) ∉ D \\ α {T}_{rec , N - 1} ( u , v ) & if ( u , v ) ∈ D\end{matrix}$$

Where the scale factor α is a constant (a tuneable parameter) governing the proportion of energy directed into region D, which controls the efficiency-contrast trade-off of windowed IFTA. For example, making the “noise region” brighter improves the quality of the window sub-region, which suffers a loss of brightness. As an example, the window can be provided as a bounding rectangular box within the replay field. In an example, the region D at least partially surrounds the windowed region.

As in FIG. 4B, the image data produced in block 406 is converted into hologram data in block 408. Blocks 410, 412, 414 and 418 are the same as described above for FIG. 4B.

In block 420, a process similar to that described in block 406 is performed again but using the retrieved phase, ϑ_{rec,K-1}(u, v) from block 414, and the reconstructed image data, T_{rec,K-1}(u, v) obtained in block 412. That is, the initial image data of this frame is modified depending upon whether the pixel is within the noise region.

As such, in block 420, constrained image data for the next iteration K is determined in the following way:

$${T}_{K} ( u , v ) = \{ \begin{matrix}\sqrt{I ( u , v )} {e}^{i {ϑ}_{rec , K - 1} ( u , v )} & if ( u , v ) ∉ D \\ α {T}_{rec , K - 1} ( u , v ) & if ( u , v ) ∈ D\end{matrix}$$

Where the scale factor α may be the same (or different) to the scale factor in block 406.

This process is repeated for each iteration, and the result is that the region D contains more noise than the window region and as such, the window region is of higher quality. After K iterations, the phase retrieved in block 414 for the final iteration and the reconstructed image data determined in block 412 is passed to the next frame in block 416. These then provide inputs in block 404 for the next frame.

It will be appreciated that FIG. 4A can also be modified to include windowed IFTA, in some examples. For example, although FIG. 4A does not have iterations within the frame, blocks 404 and 406 of FIG. 4A can be modified in the same way as described here in FIG. 4C.

Furthermore, although FIGS. 3A and 3B describe the first frame of video data, block 306 of FIGS. 3A and 3B can be modified in a similar way as described here in FIG. 4C. For example, block 306 may be modified to add random complex data (with a certain amplitude/amplitude distribution) in the region D in place of T_{rec,N-1}(u, v), as well as using the random phase data outside of region D. This process can be used to control the brightness of the first frame.

In the above examples, it is assumed that the image and hologram is of a single colour. However, in some examples, a colour hologram can be displayed, such as a “full colour” (RGB) hologram. For example, a single phase-only SLM can be used to produce time-sequential holograms for three different wavelengths, such as λᵣ, λ_{g}, λ_{b} corresponding to red, green and blue light. In another example the full colour hologram can be produced using a SLM for each colour.

In full colour holograms, the Field of View (FOV) for a phase-only SLM is proportional to the wavelength that it is illuminated by, because longer wavelengths are diffracted more than shorter wavelengths. It may therefore be useful to scale the green and red images so that their respective FOVs overlap with the FOV of the blue image, thereby using the blue FOV as the window to optimise. This results in a better image quality for green and red holograms. Thus, typically, the content from the longer wavelengths is scaled down to fit inside the FOV of the shortest wavelength, leaving some of the FOV unused.

FIG. 4D depicts an example of blue, green and red images. As shown, the blue image is unscaled, the green image is scaled by λ_{b}/λ_{g} and the red image is scaled by λ_{b}/λ_{T}, the result being that the green and red holograms are viewed as the same size as the blue hologram, as a result of diffraction. This scaling can be performed in conjunction with Windowed IFTA, with different sized windows to generate holograms for the green and red images. As such, FIG. 4D also depicts the region D surrounding the green and red images, the region D being larger for longer wavelengths. For the blue image, the region D has an area of zero.

Accordingly, D is dependent on the colour, and can be determined for each colour by:

$${D}_{g} = \{ ( u , v ) : u > \frac{{u}_{b} {λ}_{b}}{{λ}_{g}} or v > \frac{{v}_{b} {λ}_{b}}{{λ}_{g}} \} \\ {D}_{r} = \{ ( u , v ) : u > \frac{{u}_{b} {λ}_{b}}{{λ}_{r}} or v > \frac{{v}_{b} {λ}_{b}}{{λ}_{r}} \} \\ {D}_{b} = \{ ( u , v ) : u > {u}_{b} or v > {v}_{b} \}$$

Where D_{g} is the noise region for green, Dᵣ is the noise region for red and D_{b} is the noise region for blue. u_{b} and v_{b} are chosen as the proportion of the target region occupied by the blue target image, i.e., 0<u_{b}≤uₘₐₓ, and 0<v_{b}≤vₘₐₓ, where uₘₐₓ and vₘₐₓ are the maximum values attained by u and v respectively. A smaller value for u_{b} or v_{b} will result in higher image quality but a smaller addressable area. In the example of FIG. 4D, u_{b}=uₘₐₓ, and v_{b}=vₘₐₓ, so D_{b} is empty (or zero), i.e., the content for blue occupies the entire addressable area.

Accordingly, the steps described in FIG. 4C can be repeated for each colour image for the frame, where the region D is dependent on the particular colour of the image being processed. The result is that when these three holograms are displayed, the three holograms will line up, and the different sized noise regions will not overlap with the area of interest (i.e., the star in FIG. 4D).

In any of the above examples, the noise region can be filtered out using a physical filter positioned at a certain distance away from the SLM. For example, a filter having an appropriately sized aperture can be positioned in or near to a Fourier plane of the SLM and used to block out the noise region so that a viewer does not view the noisier region of the hologram.

### Example Methods for Displaying Three-Dimensional CGH Images

The methods described above with reference to FIGS. 3A, 3B, 4A, 4B and 4C are suitable for two-dimensional video data for display as a CGH, such as showing a flat image at a particular perceived distance from the viewer. Example methods which can apply a similar method to the display of three-dimensional video data will now be described.

One way of generating a three-dimensional CGH image for display (which may form a frame of video data) is to separate it into two or more layers, each layer representing a two-dimensional slice of the three-dimensional image. Each layer is processed separately and summed to create 3D CGH data. This layer-based approach can introduce additional error when used with iterative methods which take a previous result as a seed or starting point for a next iteration. When the layers are summed, the summing process can itself create additional errors because the summing action means that the optimisation of one layer can negatively impact another. (Consider, for example, that two layers require values of +1 and −1 in the complex plane. The sum of those layers results in a value of zero at that position, which the phase-modulating display technology cannot produce. This potentially introduces error and loses the benefit of the iterative processing on each layer. In this case the sum may be of worse quality than the individual hologram of each layer.)

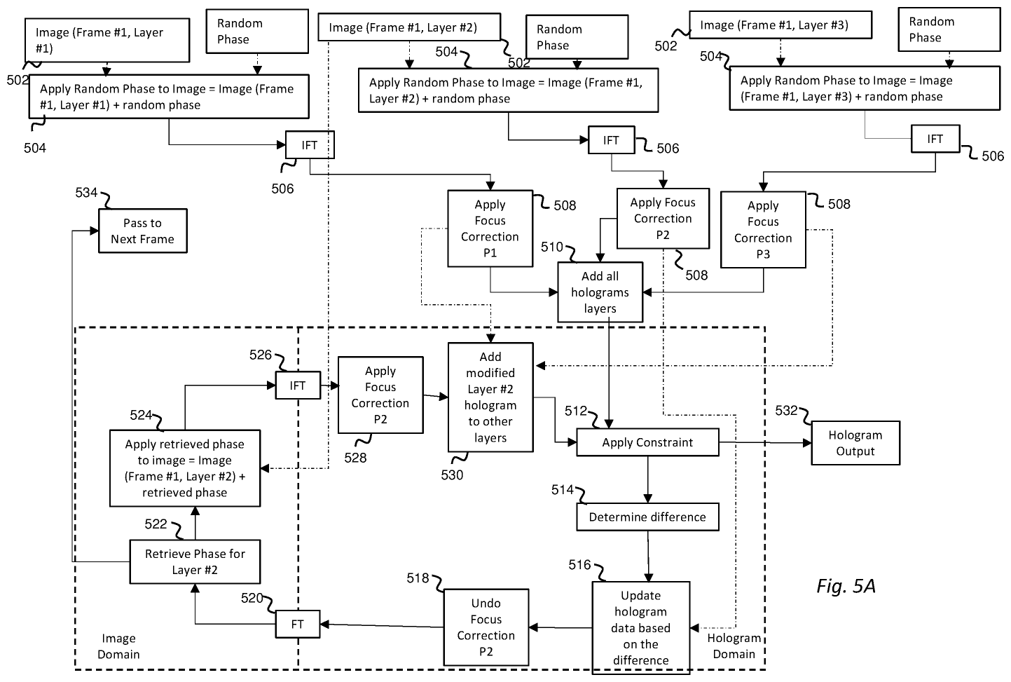

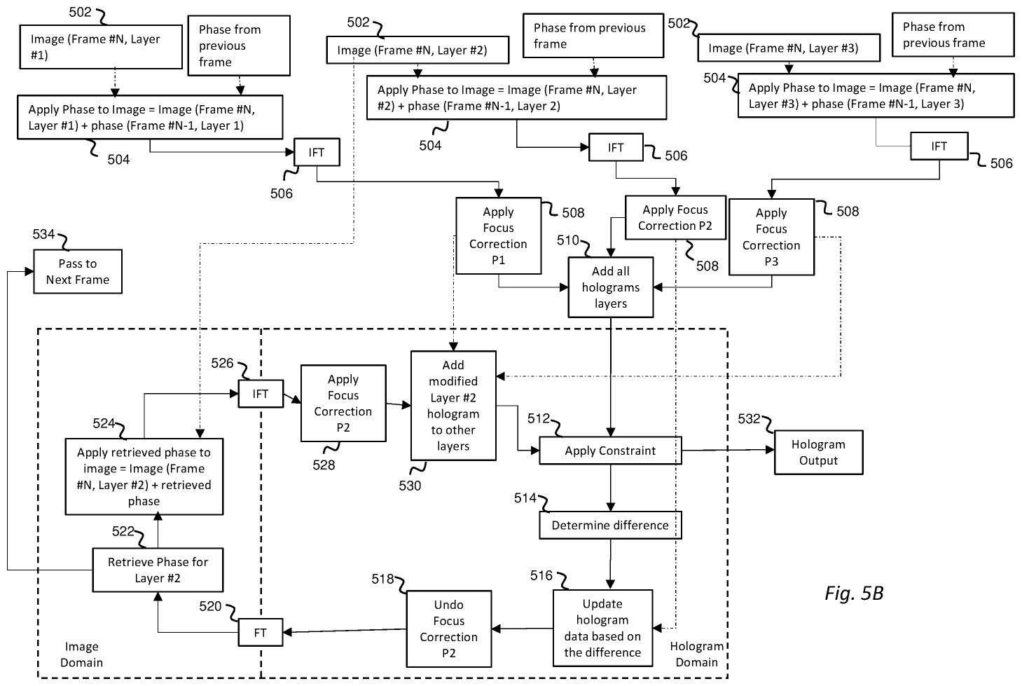

FIGS. 5A and 5B depict flow diagrams of a method of generating a hologram from a three-dimensional image, where the three-dimensional image comprises a plurality of two-dimensional image layers. As will be explained in more detail below, it has been found that iterative processing can be applied to layer-based three-dimensional CGH data by providing feedback of the error to at least one of the constituent layers. In broad overview, the process of FIGS. 5A and 5B involves updating hologram data of at least one layer of the image based on the hologram data of the other layers of the image (in addition to passing constraining data from a previous frame). The updated at least one layer adjusts the overall three-dimensional hologram data to improve the displayed image quality, for example by ensuring the three-dimensional data has a constant amplitude.

The process of FIG. 5A involves generating hologram data for each layer in the frame. In this example there are three layers, but in other examples, there may be any number of layers, so the method is not limited to three layers. FIG. 5A is an example process for a first frame of the video data and FIG. 5B is an example process for a second frame (and subsequent frames) of the video data.

The process of FIG. 5A begins by obtaining/receiving initial image data for each layer of the first frame of the video data, as shown in block 502. As mentioned, this is obtained by separating the three-dimensional image data into a number of layers. For example, starting with the first, initial frame (Frame #1) of the video data, the three-dimensional image data is separated into a plurality of layers (in this example, three layers, Layer #1, Layer #2 and Layer #3).

In some examples, the three-dimensional image data is represented by a three-dimensional array, having an x and y dimension for the image, and a z dimension corresponding to a particular layer number (perceived distance). In some examples, the layers will be disjointed in the sense that no same pixel (of location (x, y)) in different layers can be simultaneously non-zero. Consequently, for any given “pixel”, the image data has only one non-zero value, rather than multiple non-zero values (such as a non-zero value in different layers). Put another way, the displayed data does not include any transparency; the nearest occupied layer of a particular x-y position causes all layers behind that layer to be occluded and the value of the pixel in those layers behind is set to zero.

In some examples, because each pixel in the image essentially corresponds to only one layer, the three-dimensional image data can be collapsed down, and therefore represented by a two-dimensional array, having x and y dimensions. As an example, a pixel having a non-zero value in location (x₁, y₁) may correspond to layer 2, and an adjacent pixel (x₂, y₁) having a non-zero value may correspond to layer 3. Thus, when the image data is separated into different layers, the initial image data for layer 2 will be non-zero in location (x₁, y₁) and zero in location (x₂, y₁). Similarly, the initial image data for layer 3 will be non-zero in location (x₂, y₁) and zero in location (x₁, y₁).

Other ways of representing three-dimensional image data are also envisaged.

Returning to FIG. 5A, block 502 for a particular layer may therefore involve extracting initial image data for that particular layer from the three-dimensional image data array.

Given that this is the first frame (Frame #1) of the video data, the process involves, in block 504, applying random phase data to the initial image data received in block 502 to generate image data for each of the (three) layers. This step essentially corresponds to step 306 in FIGS. 3A and 3B, but is performed separately for each layer. As mentioned, the initial image data may have zero and non-zero values.

In block 506, the image data produced in block 504 is converted into hologram data for each layer. In this example, this conversion comprises performing an Inverse Fourier Transform on the image data to produce/generate the hologram data.

In block 508, the hologram data is adjusted based on an appropriate focus factor. The focus factor depends on the depth of the layer within the three dimensional image, and ensures that the three dimensional image is reconstructed correctly. As mentioned, this process is described in more detail in PCT patent application publication number WO2020/148521. In some examples, block 508 is omitted, or is performed later in the process.

In block 510, the hologram data from all layers is combined to generate combined hologram data. For example, the hologram data may be added/summed together. As mentioned, this hologram data may have been also adjusted by the focus factor discussed in block 508.

In block 512, the combined hologram data is quantized/constrained by applying a constraint (or constraints) to the combined hologram data, thereby to produce constrained hologram data. In some examples, the constraint(s) may be based on constraints of the SLM, used to display the CGH. This step may therefore be similar to block 310 of FIGS. 3A and 3B. In some examples, the constraint(s) may additionally or alternatively be to ensure that the combined hologram data has a constant amplitude.

In block 514, an “error” is determined, where the error corresponds to a difference between the combined hologram data (generated in block 510 (or 530 as will be described below)) and the constrained hologram data (generated in block 512).

The value of the constant amplitude, to which data may be constrained in block 512, may be chosen to reduce the average error generated in block 514. For example, the value of the constant amplitude may be chosen so that the total amplitudes squared of the unconstrained and constrained combined hologram data are equal.

In block 516, the hologram data of at least one layer is updated/adjusted based on this error. In this particular example, only one layer (the second layer) is being updated, so the second layer hologram data from block 508 (or 506, if block 508 is omitted) is updated. For example, the error may be added or subtracted from the second layer hologram data to generate error adjusted hologram data.

In block 518, the error adjusted hologram data is adjusted to remove the previously applied focus factor (if such a focus factor had been previously applied).

In block 520, for each layer where the hologram data has been adjusted based on the error, the error adjusted hologram data is converted back into image data to generate error adjusted image data. In this example, this conversion comprises performing a Forward Fourier Transform on the error adjusted hologram data to produce the error adjusted image data. In this example, where only the second layer hologram data is being adjusted, only second layer error adjusted image data is generated.

In block 522, constraining data is determined from the error adjusted image data produced in block 520. In this example, the constraining data is phase data that has been extracted/retrieved from the error adjusted image data. This step is therefore similar to block 314 in FIGS. 3A and 3B.

In block 524, the initial image data received/obtained in block 502 is constrained again using the constraining data determined in block 522. In this example where only the second layer is being updated, it is the initial image data of the second layer that is constrained. Block 524 therefore generates constrained image data. In this example, where only the second layer hologram data is being adjusted, only constrained second layer image data is generated. This step is therefore similar to block 320 in FIG. 3B.

In block 526, the constrained image data is converted into updated hologram data. In this example, this conversion comprises performing an Inverse Fourier Transform on the constrained image data to generate the updated hologram data. In this example, where only the second layer hologram data is being adjusted, only updated second layer hologram data is generated. The updated hologram data generated in block 526 differs from original hologram data generated in block 506 because the hologram data has been updated based on the error (i.e. the difference between the combined hologram data and the constrained hologram data) as well as the constraint applied in block 524.

The process continues to block 528, in which the updated hologram data is adjusted based on an appropriate focus factor. In some examples, block 528 is omitted, or is performed later in the process.

In block 530, the hologram data from all layers (including any updated hologram data from block 528 (or block 526, if block 528 is omitted)) is combined to generate combined hologram data. For example, if the second layer hologram data has been updated, then block 530 comprises adding the first layer hologram data (generated in block 508, or block 506, if block 508 is omitted) to the updated second layer hologram data (generated in block 528, or block 526 if block 528 is omitted) and the third layer hologram data (generated in block 508, or block 506, if block 508 is omitted). Block 530 is therefore similar to block 510, but the updated hologram data is accounted for.

Next, block 512 may be repeated again such that the new/updated combined hologram data from block 530 is constrained/quantised again based on constraints of the SLM.

This constrained hologram data may then be output in block 532, so that a three-dimensional hologram for the first layer can be displayed by the SLM.

In some examples, the process stops at block 532. However, in other examples, the process is repeated iteratively. For example, the process may be repeated until the difference between the combined hologram data and the constrained hologram data (determined in block 514) satisfies a threshold criterion. For example, the threshold criterion may require the difference to have been minimized or fallen below a threshold (i.e. has converged). Accordingly, in such cases, blocks 514-530 are repeated again such that one iteration has occurred. Steps 512-530 may be repeated/iterated over any desired number of times so that the hologram data of the at least layer is iteratively updated based on the hologram data of the other layers.

By following the process of FIG. 5A, the error created by summing iteratively determined layers is addressed. It has been found that this error can be accounted for in a single layer (the second layer in this example), although other examples may distribute the error across a plurality of layers. For example, the error determined in block 514 may be divided between two layers (such as layers 1 and 2) rather than just one layer, meaning that two layers may have their hologram data updated during that iteration. In some examples, the layer(s) that is/are updated varies between iterations of blocks 512-530. For example, the second layer hologram data may be updated on the first iteration, then in block 516, the first or third layer hologram data may be adjusted based on the difference determined in block 516. Block 516 may therefore involve determining which layer is to be updated and updating the hologram data of that layer. In some examples, the layer with the highest energy may be updated, such that block 516 also involves determining the energy of each layer and updating the layer with the highest energy. The inventors have found that only updating a single layer at any one time still provides the benefit, without increasing the processing resources that would otherwise be needed to update multiple layers simultaneously.

In some examples, the updated hologram data is output (in block 532) and displayed every iteration. Although the first few iterations may produce hologram data that results in a hologram with relatively high noise, the later iterations will produce holograms with less noise as the solution converges. In some examples, a hologram is displayed less often than for every iteration. For example, a hologram may be displayed for every other iteration that is performed. Other examples are also possible.

Blocks 510-530 can be represented mathematically, for example, in block 510, the hologram data from the first layer, hol #1, the second layer, hol #2, and the third layer, hol #3, are combined to generate combined hologram data, hol123:

hol123(x,y)=hol#1(x,y)+hol#2(x,y)+hol#3(x,y)

In block 512, the combined hologram data is quantized/constrained based on the SLM to produce constrained hologram data holQuant:

holQuant(x,y)=QuantizeHologram(hol123(x,y))

Where QuantizeHologram is any suitable quantization function, as discussed above. In block 514, the difference, holError, between the combined hologram data and the constrained hologram data is determined:

holError(x,y)=holQuant(x,y)−hol123(x,y)

In block 516, the hologram data of at least one layer (in this example, the second layer) is updated/adjusted based on the difference to generate error adjusted hologram data, hol #2Error:

hol#2Error(x,y)=hol#2(x,y)+holError(x,y)

In some examples, block 518 is performed, such that the inverse of the focus correction, ξ₂, applied in block 508, is applied to the error adjusted hologram data:

hol #2Error(x,y)′=hol #2Error(x,y)e^{-iϑ}^{₂}^{(x}^{²}^{+y}^{²}⁾

Where

$${ξ}_{2} = \frac{π}{λ {z}_{q}} ,$$

and λ is the wavelength of the light emitted by the illumination source and z_{q} is the depth of the layer, as discussed in WO2020/148521.

In block 520, the error adjusted hologram data (or the unfocussed error adjusted hologram data, if block 518 is performed) is converted back into image data to generate error adjusted image data, T_{Error}, via the Forward Fourier Transform:

T_{Error}(u,v)=F{hol#2Error(x,y)′}

In block 522, the constraining data, phase data in this example, ε_{Error} is retrieved from the error adjusted image data:

ε_{Error}(u,v)=∠T_{Error}(u,v)

In block 524 the constraining data ϑ_{Error} from block 522 is added to the initial image data for the layer, I_{Layer}, to produce constrained image data T_{Updated} for the next iteration in the following way:

T_{Updated}(u,v)=\sqrt{I_{Layer}(u,v)}e^{iϑ}^{_{Error}}^{(u,v)}

In block 526, the constrained image data is converted into updated hologram data, hol #2_{updated}, via the Inverse Fourier Transform:

hol #2_{updated}(x,y)=F⁻¹{T_{Updated}(u,v)}

In some examples, block 528 is performed, such that the focus correction of block 508 is reapplied to the updated hologram data:

hol #2_{updated}(x,y)′=hol #2_{updated}(x,y)e^{iξ}^{₂}^{(x}^{²}^{+y}^{²}⁾

In block 530, the hologram data from all layers (including any updated hologram data) is combined to generate combined hologram data:

hol123_{updated}(x,y)=hol #1(x,y)+hol #2_{updated}(x,y)′+hol #3(x,y)

This “updated” combined hologram data then forms the combined hologram data for the next iteration.

FIG. 5A finally depicts a process step in block 534 in which the constraining data determined in block 522 is passed to the corresponding layer in the next frame of the video data, in the same way as described for blocks 316 and 416. In examples where block 522 is performed more than once for a particular layer (as would happen if the steps above are performed iteratively), it is preferred that the constraining data passed to the next frame in block 534 is the constraining data determined from the final iteration (i.e. the last time block 534 is performed for that layer). This produces a more optimal input for the next frame, which should improve the quality of the hologram of the next frame, therefore improving the initial hologram output of the next frame, compared to using data of an earlier iteration.

As mentioned, in some examples, the three-dimensional image data can be disjointed in the sense that no same pixel (of location (x, y)) can be simultaneously nonzero for different layers, so that any given non-zero pixel corresponds to image data for only one layer. In some examples, the constraining data is represented as a single array of constraining data that is “shared” between layers. For example, there may be a three-dimensional “global” constraining data array, where the constraining data for the layers are also disjointed, such that no same constraining data element (of location (x, y)) in different layers can be simultaneously non-zero. Consequently, for any given element, the global constraining data array has only one non-zero value, rather than multiple non-zero values (such as one non-zero value for each layer). The three-dimensional constraining data array can then be collapsed down, and represented by a two-dimensional global constraining data array, having x and y dimensions. As an example, an element having a non-zero value in location (x₁, y₁) may correspond to layer 2, and an adjacent element (x₂, y₁) having a non-zero value may correspond to layer 3. Thus, the constraining data could be separated into different layers, where the constraining data for layer 2 will be non-zero in location (x₁, y₁) and zero in location (x₂, y₁). Similarly, the constraining data for layer 3 will be non-zero in location (x₂, y₁) and zero in location (x₁, y₁). The number of elements in the global constraining data array will correspond to the number of pixels in the three-dimensional image data. Other ways of representing constraining data are also envisaged.

As a result, block 534 may involve updating elements of a global constraining data array where the initial image data for that layer (in this case, Layer #2) is non-zero. Thus, it is only constraining data relevant for that particular layer that is passed to the corresponding layer in the next frame.

Because the constraining data is based on the particular layer being updated, it is preferred that every layer (i.e. all three layers in the example of FIG. 5A) is updated at least once (i.e. blocks 516-530 are performed at least once for each layer). This means that constraining data is determined for each layer (in block 522) meaning that every layer in the next frame of the video data can be based on constraining data from the previous iteration, rather than being based on random phase.

Accordingly, the process then proceeds to FIG. 5B, where the process steps of FIG. 5A are repeated but instead of applying random phase data, the constraining data determined in block 522 is used to constrain/modify the initial image data of the second/subsequent frame.

FIG. 5B therefore corresponds almost exactly to FIG. 5A, but the image data obtained in block 502 of FIG. 5B is for the second (or the N^{th}) frame, and instead of applying the random phase data in block 504, the constraining/phase data from the previous frame, which in this example is from a corresponding layer is applied. The process of FIG. 5B can, for example, be applied to the second, third and further frames. Since the number of elements in the global constraining data array will correspond to the number of pixels in the three-dimensional image data, block 504 of FIG. 5B for a particular layer will use only relevant constraining data from the global constraining data array (i.e. the constraining data will come from elements where the corresponding pixels in the initial image data for that layer is non-zero). This ensures that constraining data applicable to that layer only is used.

If, as may be the case, not every layer of the previous frame had been updated (meaning that constraining data had not been determined for that layer in the previous frame), random phase data could be used for that particular layer instead of constraining data from a previous frame. In other examples, however, constraining data can be determined based on the hologram data for the previous frame for that layer. This can be determined by quantizing/constraining the hologram data for that layer by applying a constraint (or constraints) to the hologram data, thereby to produce constrained hologram data (in the same way as described in blocks 310, 410). From here, the constrained hologram data can be converted back into image data by performing a Forward Fourier Transform on the constrained hologram data to produce further image data (in the same way as described in blocks 312, 412). Finally, the constraining data used for the next frame can be determined from the image data (in the same way as described in blocks 314, 414).

As mentioned earlier, in many applications, much of the difference between successive video frames is due to movement of the viewing position or the object being viewed. This difference, due to motion, reduces the effectiveness of the previous frame as a starting point for the calculation of the next frame, as was described above in FIGS. 3A-5B.

To compensate for this, an additional step may be incorporated into FIGS. 3A-5B. This involves translating the constraining data determined in block 314 and/or 414 and/or 522 by a vector that minimises the difference in amplitude between frames. This translated constraining data provides an improved starting point for the next frame.

For example, the phase data ϑ_{K-1} from a previous frame (K−1), given a vector (p, q) corresponding to the average displacement of the image between frames, can be applied to the initial image data of the subsequent frame, I_{K}, in the following way:

T_{K}(u,v)=I_{K}(u,v)e^{iϑ}^{_{K−1}}^{(u-p,v-q)}

The value of ϑ_{K-1} at coordinates (u-p, v-q) lying outside the original extent of the image may be defined as zero or randomly drawn from a uniform distribution over {0, 2π}. Methods of estimating the interframe motion vector (p, q) are widely known and used in the field of video compression.

Accordingly, block 314 and/or 414 and/or 522 may additionally include a step of adjusting the constraining data based on a change in viewing position between the previous and current frames. This change in viewing position may be represented as a vector, which is used to translate the constraining data. This “inter-frame motion vector” may be estimated either from the video data, or from the change in position and/or orientation of the display 100, as determined by movement sensors, for example. Blocks 314, 414, 522 may therefore also comprise determining the change in viewing position prior to adjusting the constraining data. Blocks 316, 416, 534 may therefore comprise passing this adjusted constraining data to the next frame, such that the hologram data of the next frame is based on the change in viewing position between the two frames. In some examples, these additional steps are only performed when necessary, such as when the change in viewing position exceeds a particular threshold.

### Example Methods for Static Images

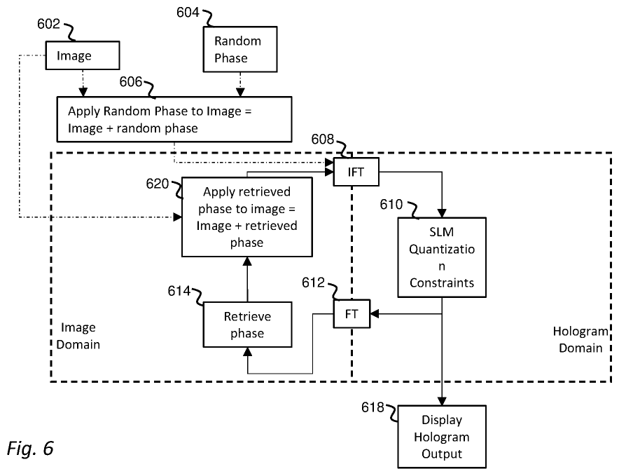

In the above examples described in FIGS. 3A-5B, the image data is related to a frame in video. However, in some examples, static images can be iteratively processed and displayed in a similar way. FIG. 6 therefore depicts an example flow diagram of a method of displaying a hologram from a static two-dimensional image. Such static images may be, for example a user-interface or augmented reality display information. Static may mean that it changes relatively infrequently, for example the update frequency is lower than about 10 Hz or lower than about 1 Hz.

The method begins by obtaining/receiving initial image data, as shown in block 602. The initial image data contains an array of data representative of the two-dimensional image to be displayed.

Block 604 depicts random or pseudo-random phase data being generated or received. Next, in block 606, the initial image data is modified/constrained by applying the random phase data to the initial image data to generate image data.

In block 608, the image data produced in block 606 is converted into hologram data. In this example, this conversion comprises performing an Inverse Fourier Transform on the image data to produce/generate the hologram data.

In block 610, the hologram data is quantized/constrained by applying a constraint (or constraints) to the hologram data, thereby to produce constrained hologram data. As discussed, the constraint(s) are based on the constraints of the SLM used to display the hologram.

In block 612, the constrained hologram data is converted back into image data (which is different to the image data produced in block 606 due to the constraints applied in block 610). In this example, this conversion comprises performing a Forward Fourier Transform on the constrained hologram data to produce the (second) image data produced in block 612.

In block 614, constraining data is determined from the second image data produced in block 612. In this example, the constraining data is phase data that has been extracted/retrieved from the second image data. It will be noted that the constraining data is different to the random phase data received/generated in block 604 due to the SLM quantization constraints applied in block 610.

In block 620, the initial image data received/obtained in block 602 is constrained again using the constraining data determined in block 614. Accordingly, in block 620, the initial image data is modified/constrained by applying the constraining data to the initial image data to generate constrained image data. The constrained image data generated in block 620 then forms the image data for block 608. Accordingly, from here, block 608 is performed again using the constrained image data generated in block 620 rather than the image data generated in block 606. Blocks 610, 612, 614 and, optionally, 618 are repeated again such that one full iteration has occurred (k=1). Steps 608, 610, 612, 614 and 620 may be repeated any desired number of times (k>1).

Block 618 comprises outputting the constrained hologram data, either every iteration, or at least twice before the iteration ends. The constrained hologram data may then be displayed by the SLM 104. By displaying these early iterations, the eye/brain of the observer can apply an averaging process when these interim holograms are displayed such that the hologram is perceived as less noisy in addition to the displayed hologram converging on a more accurate display of the image. In some examples, a hologram is displayed less often than for every iteration. For example, a hologram may be displayed for every other iteration that is performed, or as often as a display can accept a new image for display. Other examples are also possible.

In some examples, the constrained hologram data is processed further before being displayed by the SLM 104. In alternative examples, it is not the constrained hologram data that is output in block 618, but rather the hologram data generated in block 608. The hologram data may be constrained/quantized at a later step, perhaps after being additionally processed.

### Example Methods for Colour CGH Displays

The above processes have been described in the context of an illumination source outputting electromagnetic radiation having a single wavelength (or a narrow range of wavelengths) corresponding to a particular colour, such as red, green or blue. It will be appreciated that these processes can also be applied to other wavelengths to achieve, for example, full colour (RGB) holograms.

For example, a single illumination source (or separate illumination sources) may output electromagnetic radiation having two or more wavelengths, and in a particular case, may output electromagnetic radiation at three wavelengths corresponding to red, green and blue.

In a first example, a plurality of illumination sources substantially simultaneously emit light towards a plurality of modulators (such as SLMs), where each illumination source outputs light having a particular wavelength and each modulator is configured for a particular one of those wavelengths. Optical assemblies, such as one or more mirrors or lenses, can direct the light from each modulator so that they combine at the viewing plane, thereby producing a coloured hologram.

In a second example, each individual colour is displayed sequentially (time multiplexed) using a single modulator (such as an SLM). Some examples may use a single illumination source which can be controlled to emit light at a selected wavelength, other examples may have an illumination source for each colour. As an example, the illumination source may first emit red light, then green light and finally blue light. The modulated light arrives in rapid temporal succession at the viewing plane, at a rate sufficient to give the perception of a coloured hologram.

In the two dimensional image case, each frame of video data may comprise a plurality of substantially single-colour frames. Each single-colour frame can be processed as described above. For a three-dimensional image case, each frame of video data may comprise a plurality of image layers where each image layer comprises a plurality of substantially single-colour layers. Again, each colour layer can be processed as described above.

### Example Methods to Reduce Holographic Speckle

The methods described improve image quality by addressing low image quality caused by quantization for display, such as low contrast and holographic speckle, by computational techniques. In some examples, these computational techniques may be combined with speckle reduction techniques to further improve image quality. In particular, hardware-based speckle reduction techniques may involve activating a blurring function, which has the effect of smoothing the noise while reducing the perceived sharpness or resolution. Example hardware includes a vibrating mirror in the optical path and rotating rough surfaces in the optical path. As the methods described herein generally reduce the appearance of speckle, hardware-based speckle reduction may be applied with less intensity than prior methods, so that more detail is retained in the displayed image.

Some examples may apply the methods described in PCT/GB2021/051353 which was filed on 2 Jun. 2021 and is incorporated herein by reference. PCT/GB2021/051353 includes methods in which a hologram for display is decomposed into high pass and low pass components, such as by applying a suitable mathematical filter. The components are then displayed successively in time, so that a viewer's eye combines the components through persistence of vision, with the hardware speckle reduction applied to the lower frequency components. The higher frequency components are displayed without hardware speckle reduction, to preserve detail, while the lower frequency components benefit from reduced speckle by the hardware function.

### CONCLUSION

The present disclosure has shown several general methods for reducing quantization noise in holograms. First, iterative methods can be applied between frames of video, using data based on a previous frame to improve the image quality of a current frame. Second, iterative methods can be applied to three-dimensional holograms formed from layer data at different depths by accounting for an overall error in the sum of all layers in at least one layer. While both these can be used in isolation, they combine to improve image quality with reduced processing requirements. Third, when calculating iterative holograms which do not change during the iteration, such as for static images or for images within a frame period of video data, image quality is improved by outputting results from non-final iterations. In this way the eye both perceives a convergence to higher quality over time and additionally benefits from an averaging effect between displayed iterations. Furthermore, these computational methods of noise reduction can all give a further benefit when combined with speckle reduction techniques to further reduce the apparent noise or speckle.

The above embodiments are to be understood as illustrative examples of the invention. Further embodiments of the invention are envisaged. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

### Clauses

Further examples are set out in the following clauses:

Clause 1. A method of generating computer-generated holograms from video data comprising a plurality of frames, the method comprising:
generating hologram data of a current frame using both:
   image data of the current frame; and
constraining data, the constraining data being based on hologram data of a previous frame.

Clause 2. A method according to clause 1, comprising iteratively generating the hologram data of the previous frame using both:
image data of the previous frame; and
second constraining data, the second constraining data being based on hologram data of a previous iteration;
wherein the constraining data for the current frame corresponds to second constraining data determined during a final iteration of the previous frame.

Clause 3. A method according to any preceding clause, wherein the current and previous frames each comprise a plurality of two-dimensional image layers, and wherein the method comprises:
generating hologram data for each layer of the current frame, wherein the constraining data for each layer is based on hologram data of a corresponding layer of the previous frame;
and updating the hologram data of at least one layer of the current frame based on the hologram data of the other layers of the current frame.

Clause 4. A method according to clause 3, comprising:
iteratively updating the hologram data of the at least one layer based on the hologram data of the other layers of the current frame; and
for at least two iterations, displaying a hologram for the current frame based on:
the updated hologram data of the at least one layer; and
the hologram data of the other layers.

Clause 5. A method according to clause 3 or 4, wherein updating the hologram data of at least one layer based on the hologram data of the other layers comprises:
updating the hologram data of only one layer of the current frame at any one time.

Clause 6. A method according to clause 1 or 2, comprising iteratively generating the hologram data of the previous frame using both:
image data of the previous frame; and
second constraining data, the second constraining data being based on hologram data of a previous iteration; and
for at least two iterations, displaying a hologram for the previous frame based on the hologram data generated during that iteration.

Clause 7. A method according to any preceding clause, wherein the constraining data is updated based on determined motion between the previous and current frames.

Clause 8. A method according to any preceding clause, further comprising displaying the hologram data, wherein the displaying the hologram data comprises using speckle reduction.

Clause 9. A method of generating a computer-generated hologram from a three-dimensional image comprising a plurality of two-dimensional image layers, the method comprising:
generating hologram data for each layer of the image; and
updating the hologram data of at least one layer of the image based on the hologram data of the other layers of the image.

Clause 10. A method according to clause 9, comprising:
iteratively updating the hologram data of the at least one layer based on the hologram data of the other layers; and
for at least two iterations, displaying a hologram based on:
the updated hologram data of the at least one layer determined during that iteration; and
the hologram data of the other layers.

Clause 11. A method according to clause 9 or 10, wherein updating the hologram data of at least one layer of the image based on the hologram data of the other layers of the image, comprises:
updating the hologram data of only one layer of the image at any one time.

Clause 12. A method according to clause 9, 10 or 11 further comprising displaying the hologram data, wherein the displaying the hologram data comprises using speckle reduction.

Clause 13. A method of displaying a computer-generated hologram from an image, the method comprising:
iteratively generating hologram data of the image using both:
   image data; and
constraining data, the constraining data being based on hologram data of a previous iteration; and
for at least two iterations, displaying a hologram of the image based on the hologram data generated during that iteration.

Clause 14. A method according to clause 13, comprising:
for every iteration, displaying a hologram of the image based on the hologram data generated during that iteration.

Clause 15. A method according to clause 13 or 14, wherein the image corresponds to a previous frame of video data comprising a plurality of frames, and the method further comprises:
generating hologram data of a current frame using both:
   image data of the current frame; and
second constraining data, the second constraining data corresponding to constraining data determined during the final iteration of the previous frame.

Clause 16. A method according to clause 13, 14 or 15, further comprising displaying the hologram data, wherein the displaying the hologram data comprises using speckle reduction.

Clause 17. A holographic display for displaying a computer-generated hologram, the display comprising:
an illumination source configured to emit at least partially coherent light;
a spatial light modulator; and
a controller configured to implement a method according to any preceding claim.

Clause 18. A holographic display for displaying a computer-generated hologram from video data comprising a plurality of frames, comprising:
an illumination source configured to emit at least partially coherent light;
a spatial light modulator; and
a controller configured to:
   generate hologram data of a current frame using both:
      image data of the current frame; and
   constraining data, the constraining data being based on hologram data of a previous frame; and
   operate the spatial light modulator to display a hologram of the current frame based on the hologram data of the current frame.

Clause 19. A method according to clause 18, wherein the controller is further configured to:
iteratively generate the hologram data of the previous frame using both image data of the previous frame and second constraining data, the second constraining data being based on hologram data of a previous iteration; and
for at least two iterations, operate the spatial light modulator to display a hologram of the previous frame based on the hologram data generated during that iteration.

Clause 20. A holographic display for displaying a computer-generated hologram from a three-dimensional image comprising a plurality of two-dimensional image layers, the holographic display comprising:
an illumination source configured to emit at least partially coherent light;
a spatial light modulator; and
a controller configured to:
   generate hologram data for each layer of the image;
   update the hologram data of at least one layer of the image based on the hologram data of the other layers of the image; and
   operate the spatial light modulator to display a hologram of the three-dimensional image based on:
   the updated hologram data of the at least one layer; and
   the hologram data of the other layers.

Clause 21. A holographic display for displaying a computer-generated hologram from an image, comprising:
an illumination source configured to emit at least partially coherent light;
a spatial light modulator; and
a controller configured to:
   iteratively generate hologram data of the image using both:
      image data; and
   constraining data, the constraining data being based on hologram data of a previous iteration; and
   for at least two iterations, operate the spatial light modulator to display a hologram of the image based on the hologram data generated during that iteration.

Clause 22. A computer program comprising instructions that, when executed by a controller of a holographic display, instructs the controller to carry out the method of any of clauses 1 to 16.

Clause 23. A processing system configured to implement the method of any of clauses 1 to 16.

1. A holographic display for displaying a computer-generated hologram from a three-dimensional image comprising a plurality of two-dimensional image layers, the holographic display comprising:
an illumination source configured to emit at least partially coherent light;
a spatial light modulator; and
a controller configured to:
generate hologram data for each two-dimensional image layer of the three-dimensional image;
update the hologram data of at least one two-dimensional image layer of the three-dimensional image based on the hologram data of the other two-dimensional image layers of the three-dimensional image; and
operate the spatial light modulator to display a hologram of the three-dimensional image based on:
the updated hologram data of the at least one two-dimensional image layer; and
the hologram data of the other two-dimensional image layers.

2. A holographic display according to claim 1, wherein the controller is configured to:
iteratively update the hologram data of the at least one two-dimensional image layer based on the hologram data of the other two-dimensional image layers; and
for at least two iterations, operate the spatial light modulator to display a hologram based on:
the updated hologram data of the at least one two-dimensional image layer determined during that iteration; and
the hologram data of the other two-dimensional image layers.

3. A holographic display according to claim 1, wherein to update the hologram data of at least one two-dimensional image layer of the three-dimensional image based on the hologram data of the other two-dimensional image layers of the image, comprises the controller being configured to:
update the hologram data of only one two-dimensional image layer of the three-dimensional image at any one time.

4. A holographic display according to claim 1, wherein to operate the spatial light modulator to display the hologram, comprises the controller being configured to operate the spatial light modulator to display the hologram data using speckle reduction.

5. A holographic display according to claim 1, wherein the three-dimensional image comprising the plurality of two-dimensional image layers corresponds to a current frame of video data, the video data comprising a plurality of frames including the current frame and a previous frame, each of the plurality of frames being a three-dimensional image comprising a plurality of two-dimensional image layers, wherein to generate hologram data for each two-dimensional image layer of the three-dimensional image comprises the controller being configured to, for each two-dimensional image layer of the plurality of two-dimensional image layers:
generate hologram data of the current frame using both:
two-dimensional image data of the current frame; and
constraining data, wherein the constraining data is based on hologram data of the previous frame.

6. A holographic display according to claim 5, wherein the constraining data comprises a two-dimensional array comprising constraining data for at least two two-dimensional image layers.

7. A holographic display according to claim 5, wherein the controller is further configured to, for each two-dimensional image layer of the plurality of two-dimensional image layers of the previous frame, iteratively generate the hologram data of the previous frame using both:
two-dimensional image data of the previous frame; and
second constraining data, the second constraining data being based on hologram data of a previous iteration;
wherein the constraining data for the current frame corresponds to second constraining data determined during a final iteration of the previous frame.

8. A holographic display according to claim 5, wherein the controller is further configured to:
for each two-dimensional image layer of the plurality of two-dimensional image layers of the previous frame, iteratively generate the hologram data of the previous frame using both:
two-dimensional image data of the previous frame; and
second constraining data, the second constraining data being based on hologram data of a previous iteration; and
for at least two iterations, operate the spatial light modulator to display a hologram for the previous frame based on the hologram data generated during that iteration.

9. A holographic display according to claim 5, wherein the constraining data is updated based on determined motion between the previous frame and the current frame.

10. A non-transitory computer-readable medium comprising instructions that, when executed by a controller of a holographic display, instructs the controller to generate a computer-generated hologram from a three-dimensional image comprising a plurality of two-dimensional image layers by:
generating hologram data for each two-dimensional image layer of the three-dimensional image; and
updating the hologram data of at least one two-dimensional image layer of the three-dimensional image based on the hologram data of other two-dimensional image layers of the three-dimensional image.

11. A non-transitory computer-readable medium according to claim 10, wherein the instructions, when executed by the controller, instruct the controller to:
iteratively update the hologram data of the at least one two-dimensional image layer based on the hologram data of other two-dimensional image layers; and
for at least two iterations, cause a hologram to be displayed based on:
the updated hologram data of the at least one two-dimensional image layer determined during that iteration; and
the hologram data of other two-dimensional image layers.

12. A non-transitory computer-readable medium according to claim 10, wherein updating the hologram data of at least one two-dimensional image layer of the three-dimensional image based on the hologram data of the other two dimensional image layers of the image, comprises:
updating the hologram data of only one dimensional image layer of the three-dimensional image at any one time.

13. A non-transitory computer-readable medium according to claim 10, wherein the instructions, when executed by the controller, instruct the controller to display the hologram data using speckle reduction.

14. A non-transitory computer-readable medium according to claim 10, wherein the three-dimensional image comprising the plurality of two-dimensional image layers corresponds to a current frame of video data, the video data comprising a plurality of frames including the current frame and a previous frame, each of the plurality of frames being a three-dimensional image comprising a plurality of two-dimensional image layers, wherein generating hologram data for each two-dimensional image layer of the three-dimensional image comprises, for each two-dimensional image layer of the plurality of two-dimensional image layers:
generating hologram data of the current frame using both:
two-dimensional image data of the current frame; and
constraining data, wherein the constraining data is based on hologram data of the previous frame.

15. A non-transitory computer-readable medium according to claim 14, wherein the constraining data comprises a two-dimensional array comprising constraining data for at least two two-dimensional image layers.

16. A non-transitory computer-readable medium according to claim 14, wherein the instructions, when executed by the controller, instruct the controller to, for each two-dimensional image layer of the plurality of two-dimensional image layers of the previous frame, iteratively generate the hologram data of the previous frame using both:
two-dimensional image data of the previous frame; and
second constraining data, the second constraining data being based on hologram data of a previous iteration;
wherein the constraining data for the current frame corresponds to second constraining data determined during a final iteration of the previous frame.

17. A non-transitory computer-readable medium according to claim 14, wherein the instructions, when executed by the controller, instruct the controller to:
for each two-dimensional image layer of the plurality of two-dimensional image layers of the previous frame, iteratively generate the hologram data of the previous frame using both:
two-dimensional image data of the previous frame; and
second constraining data, the second constraining data being based on hologram data of a previous iteration; and
for at least two iterations, display a hologram for the previous frame based on the hologram data generated during that iteration.

18. A non-transitory computer-readable medium according to claim 14, wherein the constraining data is updated based on determined motion between the previous frame and the current frame.

19. A computer implemented method of generating a computer-generated hologram from a three-dimensional image comprising a plurality of two-dimensional image layers, the method comprising:
generating hologram data for each two-dimensional image layer of the three-dimensional image;
updating the hologram data of at least one two-dimensional image layer of the three-dimensional image based on the hologram data of other two-dimensional image layers of the three-dimensional image;
displaying a hologram of the three-dimensional image based on:
the updated hologram data of the at least one two-dimensional image layer; and
the hologram data of the other two-dimensional image layers.

20. A computer implemented method according to claim 19, wherein the three-dimensional image comprising the plurality of two-dimensional image layers corresponds to a current frame of video data, the video data comprising a plurality of frames including the current frame and a previous frame, each of the plurality of frames being a three-dimensional image comprising a plurality of two-dimensional image layers, wherein generating hologram data for each layer of the image comprises, for each two-dimensional image layer of the plurality of two-dimensional image layers:
generating hologram data of the current frame using both:
two-dimensional image data of the current frame; and
constraining data, wherein the constraining data is based on hologram data of the previous frame.
